(19) United States
(12) Patent Application Publication
(10) Pub. No.: US 2003/0160399 A1
(43) Pub. Date: Aug. 28, 2003

(54) Method and apparatus for providing a modular shielded enclosure

(75) Inventors: Jerold P. Lyons, Sparta, NJ (US); Werner Schon, Mountainside, NJ (US); John Schon, Sparta, NJ (US); Carl T. Grossi III, Wantage, NJ (US)

Correspondence Address: MOSER, PATTERSON & SHERIDAN, LLP, Suite 100, 595 Shrewsbury Avenue, Shrewsbury, NJ, 07702, US

(73) Assignee: Jerold P. Lyons.

(21) Appl. No.: 10/163,673

(22) Filed: Jun. 5, 2002

Related U.S. Application Data
(60) Provisional application No. 60/295,953, filed on Jun. 5, 2001.

(51) Int. Cl. F16J 15/08

(52) U.S. Cl. 277/650

(57) ABSTRACT

A modular, shielded enclosure engineered to provide structural security for information technology (IT), data, and telecom equipment is provided. The enclosure is composed of individual periphery shields locked together to create an airtight, thermal resistant, fire resistant, waterproof, hermetically sealed facility. In addition, a series of penetration management devices (PMD) and a control panel can be deployed. The enclosures are infinitely configurable independent structures, and may be expanded, reduced, or relocated with ease to give end-users the flexibility needed to manage the ever-changing, highly specialized IT facility.

This application claims the benefit of United States Provisional Application No. 60/295,953 filed Jun. 5, 2001, which is hereby incorporated by reference in its entirety.

The present invention relates to an apparatus and concomitant method for providing a protective enclosure. More specifically, the apparatus is a modular, shielded enclosure that is engineered to provide structural security for important assets such as information technology (IT), data, telecom equipment, and the like.

### BACKGROUND OF THE INVENTION

Information technology (IT), data, and telecom equipment are important and expensive assets in many businesses, and, as such, appropriate measures are generally taken to insure that the lifetime and functionality of such equipment are not compromised. Due to the sensitive nature of the equipment, many businesses construct facilities within their offices and buildings to protect the equipment from threats that might cause degradation, damage, failure, or consequential loss (i.e., by fire, heat, water, dust, radio frequencies, vandalism, etc.). These facilities are usually permanent sites constructed within the building as part of the occupant's initial architecture. As such, they are fixed in both location and size.

However, if such a protective facility is contemplated after the office building has been constructed, substantial modifications to the structure of the building are often required at considerable cost to meet the stringent protective requirements. Additionally, once such protective facility is integrated into the office, it is very costly to then reconfigure or to enlarge such protective facility.

Thus, a need exists for a flexible and modular approach that provides a protective enclosure within a facility for protecting sensitive equipment and data.

### SUMMARY OF THE INVENTION

In one embodiment of the present invention, a method and apparatus for providing a modular, shielded enclosure is provided. The enclosure is engineered to provide structural and environmental security for IT, data, and physical equipment, e.g., communication and computer equipment, and is intended to protect any and all contents regardless of function or type from human or environmental threats that may otherwise cause degradation, damage, failure, or consequential loss.

The present invention is a modular, shielded enclosure that provides protection to sensitive equipment and data, but is advantageously engineered to provide flexibility in its deployment as it can contain and surround unlimited areas of space. Namely, the deployment of the present modular, shielded enclosure is not required to be designed into the initial construction of the building. It is designed to be easily deployed in existing buildings.

The design and assembly of the enclosure allow not only for easy construction, but also for relocation and even expansion or reduction, should the user's needs change over time. The enclosures are infinitely configurable independent systems, and other than the structural foundation on which they are assembled, they do not rely on building architecture for structural support.

Individual periphery shields of varying heights, a series of penetration management devices (PMD), and a control panel constitute the composition of the secure enclosure. The PMD's consist of a door system for human and equipment transfer, mechanical dampers for fresh and mechanical air exchange, and carrier portals to manage wire, cable, and plumbing penetrations. These enclosures are infinitely configurable, and once installed, the entire assembly may be expanded, reduced, or even relocated. Other than the structural foundation on which the enclosure is assembled, the enclosure does not rely on building architecture for structural support. This modularity and independence provides end-users with the flexibility needed to manage the ever-changing, highly specialized, critical facility.

The enclosure can be deployed to protect contents against such threats as fire, water, heat, dust, humidity, smoke, acrid gases, radio frequencies (RF), electromagnetic interference/electromagnetic pulses (EMI/EMP), theft, vandalism, unauthorized access, construction hazards, and explosions.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a three-dimensional view of an illustrative modular enclosure of the present invention as deployed in a larger facility;

FIG. 2 illustrates a three-dimensional view of a typical embodiment of the enclosure;

FIG. 3 illustrates a top view of a typical embodiment of the modular enclosure of the present invention;

FIG. 4 illustrates an isometric drawing of a basic flat vertical shield or a standard shield of the present invention;

FIG. 5 illustrates an isometric drawing of a carrier vertical shield of the present invention;

FIG. 6 illustrates an isometric drawing of a first mechanical vertical shield of the present invention;

FIG. 7 illustrates an isometric drawing of a second mechanical vertical shield of the present invention;

FIG. 8 illustrates the front, side and top views of a basic flat vertical shield or a standard shield of the present invention;

FIG. 9 illustrates the front and top views of a carrier vertical shield of the present invention;

FIG. 10 illustrates the front and top views of a first mechanical vertical shield of the present invention;

FIG. 11 illustrates the front and top views of a second mechanical vertical shield of the present invention;

FIG. 12 illustrates a cross-sectional top view of a vertical shield of the present invention;

FIG. 13 illustrates a cross-sectional top view of a gasket that is disposed between two vertical shields of the present invention;

FIG. 14 illustrate a cross-sectional top view of a first vertical T shield of the present invention;

FIG. 15 illustrate a cross-sectional top view of a second vertical T shield of the present invention;

FIG. 16 illustrate a cross-sectional top view of an inside corner vertical shield of the present invention;

FIG. 17 illustrate a cross-sectional top view of an outside corner vertical shield of the present invention;

FIG. 18 illustrates an anchor plate of the present invention;

FIG. 19 illustrates a cross-sectional side view of the placement of a base shield relative to a vertical shield;

FIG. 20 illustrates a coping of the present invention;

FIG. 21 illustrates a cross-sectional side view of the placement of a cap shield relative to a vertical shield;

FIG. 22 illustrates an isometric view of a damper housing of the present invention;

FIG. 23 illustrates a front view and a side view of the damper housing of the present invention;

FIG. 24 illustrates a front view of a damper shield of the present invention;

FIG. 25 illustrates a cross-sectional top and side view of the damper shield of the present invention;

FIG. 26 illustrates a back view of the damper shield of the present invention;

FIG. 27 illustrates an isometric drawing of a door set of vertical door shields of the present invention;

FIG. 28 illustrates a front view and a top view for each of the vertical door shields of the present invention;

FIG. 29 illustrates an isometric cross section of the door of the present invention;

FIG. 30 illustrates a top end channel alone the periphery of the door of the present invention;

FIG. 31 illustrates a bottom end channel alone the periphery of the door of the present invention;

FIG. 32 illustrates a side end channel alone the periphery of the door of the present invention;

FIG. 33 illustrates a cross-sectional view from the hinge side of the door engaging the door frame;

FIG. 34 illustrates a cross-sectional view from the lockset side of the door engaging the door frame;

FIG. 35 illustrates a cross-sectional view from the bottom side of the door engaging the door frame;

FIG. 36 illustrates a cross-sectional view of interlocking strips on the lockset side of the door;

FIG. 37 illustrates a cross-sectional view of interlocking strips on the door head side of the door;

FIG. 38 illustrates a cross-sectional view of the bottom of the door frame;

FIG. 39 illustrates a cross-sectional view of the top and sides of the door frame;

FIG. 40 illustrates the gasket of the present invention;

FIG. 41 illustrates a table for the formulation of the gasket;

FIG. 42 illustrates an alternate shield structure;

FIG. 43 illustrates an alternate T-assembly of the present invention;

FIG. 44 illustrates an alternate structure for a cap shield of the present invention;

FIG. 45 illustrates an alternate base shield of the present invention;

FIG. 46 illustrates an alternate anchor plate of the present invention;

FIG. 47 illustrates an alignment of the front angled portion and a back angled portion of an anchor assembly of the present invention;

FIG. 48 illustrates an anchor plate alignment tool of the present invention;

FIG. 49 illustrates an interior front view of the back angled portion of the anchor plate assembly of the present invention;

FIG. 50 illustrates the alternate anchor plate assembly as deployed next to the alternate base shield of the present invention;

FIG. 51 illustrates an isometric view of a plurality of vertical shields that are deployed in conjunction with a post to form a corner of the present invention;

FIG. 52 illustrates a latching system of the present invention; and

FIG. 53 illustrates the carrier portal assembly of the present invention.

### DETAILED DESCRIPTION OF THE PREFERRED EMBODIMENT

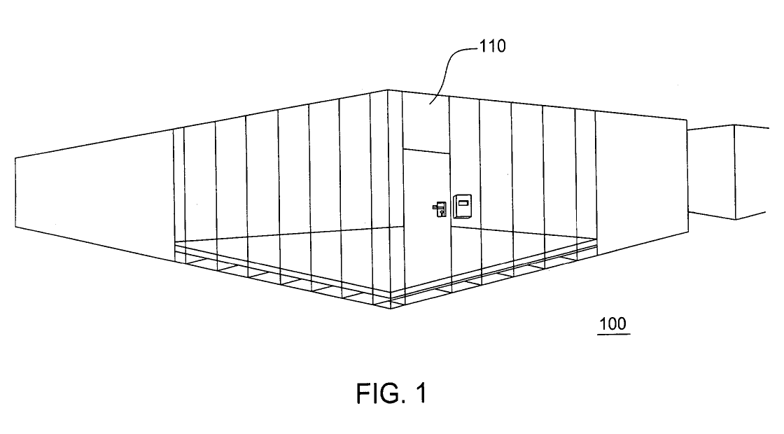

The present invention relates to a modular, shielded enclosure that is advantageously engineered to provide structural and environmental security for IT, data, and equipment, thereby protecting contents against human and/or environmental threats that may cause degradation, damage, failure, or loss. FIG. 1 shows an illustrative interior hallway of a facility 100 in which a modular protective enclosure 110 is deployed within the facility 100. The modular protective enclosure 110 is constructed from a plurality of modular shields that are described in detail below. One advantage of the present invention is the modularity, configurability and portability of the overall protective system. Namely, the modular protective enclosure 110 can be deployed within the facility 100 without special accommodation. The modular protective enclosure 110 can be deployed in existing facilities that were previously constructed in a manner that did not address the need for a protective enclosure within the facility.

Although the present invention is described as a modular protective enclosure that is deployed within a facility, those skilled in the art will realized that the present invention can be adapted to encompass the interior of an entire facility. Namely, the various shields that are disclosed below can be deployed throughout the entire facility to form a protective facility if such requirement is needed or desired.

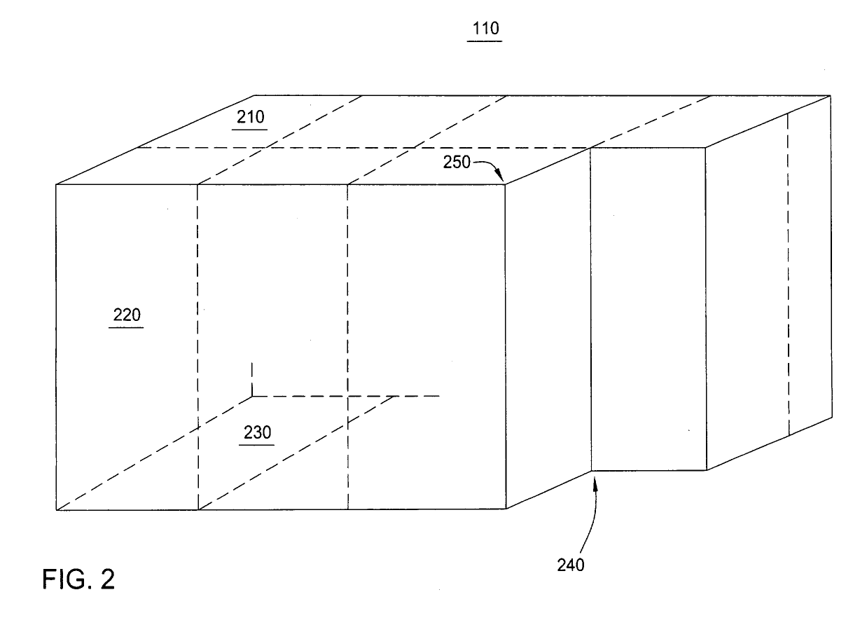

FIG. 2 illustrates a typical configuration of the enclosure 110 disclosed in the present invention. This figure is simply used to illustrate the different types of shields that can be deployed to form a modular protective enclosure 110. Since the shape, size and configuration of a protective enclosure will vary depending on the particular application, various combinations of these shields can be deployed. In other words, some of the shields may not be deployed at all if a particular application does not call for such a feature, e.g., a T shield for partitioning a room as disclosed below.

FIG. 2 illustrates a modular protective enclosure 110 that is composed of three basic types of shields: a cap shield 210, a vertical shield 220 and a base shield 230. In operation, a plurality of cap shields 210 are mated together to form the ceiling of the modular protective enclosure 110, while a plurality of base shields 230 are mated together to form the floor of the modular protective enclosure 110. Finally, a plurality of vertical shields 220 are mated to form the walls (exterior and interior) of the modular protective enclosure 110. In fact, the vertical shield 220 can be deployed in a number of different configurations, e.g., a basic flat vertical shield, an inside corner vertical shield to address corner 240, an outside corner vertical shield to address corner 250, a T shield, a mechanical shield, a damper shield, a carrier shield, a door frame shield, and a door shield. Each of these shields is described further below.

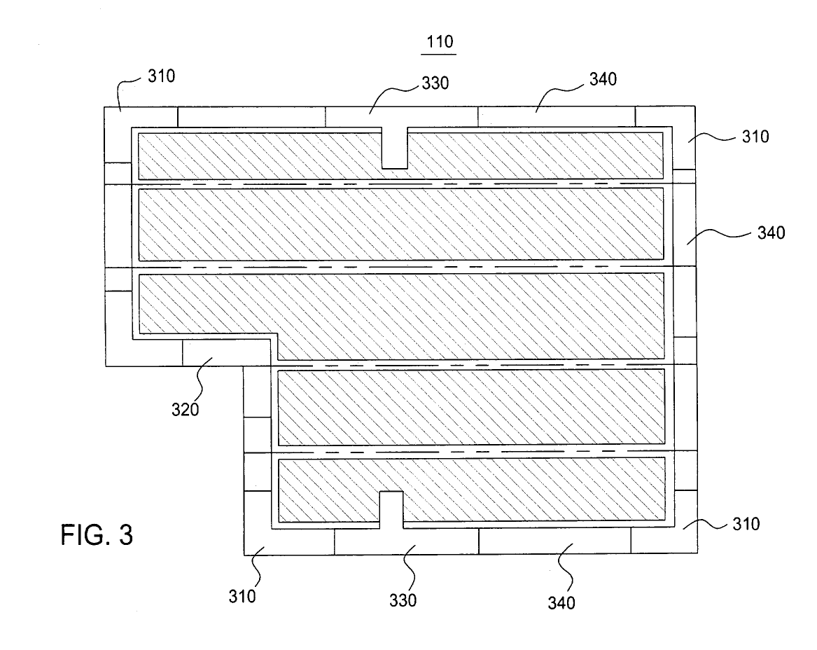

FIG. 3 illustrates a cross sectional top view of a modular protective enclosure 110. Specifically, FIG. 3 illustrates a plurality of flat vertical shields 340, a plurality of outside corner vertical shields 310, an inside corner shield 320, and a pair of T shields 330. Additional vertical shields (not shown) can be coupled to the pair of T shields to serve as a partition to define rooms within the enclosure 110. FIG. 3 illustrates the modularity and flexibility of the present invention, where different types of vertical shields can be configured to form the interior and exterior walls for any desired shape and size as required for a particular deployment. It should be noted that specialized vertical shields for providing access to the protective enclosure 110 is not shown in FIG. 3 for simplicity.

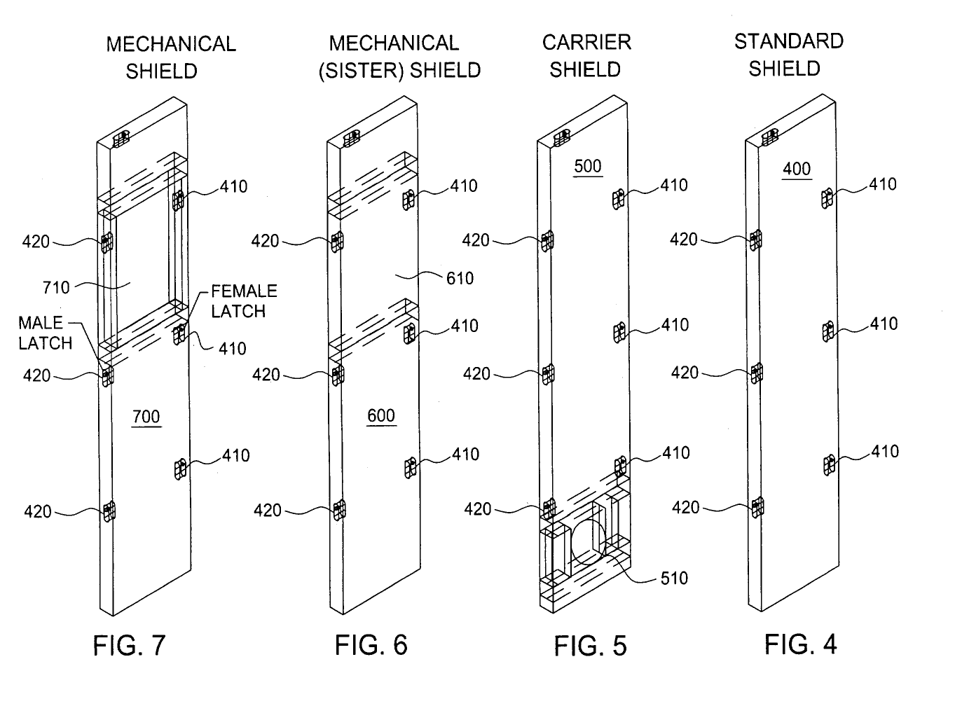

FIGS. 4-7 illustrate isometric drawings of a plurality of vertical shields, e.g., a standard flat vertical shield 400, a carrier vertical shield 500, a first mechanical vertical shield 600 and a second mechanical vertical shield 700. Although these vertical shields are designed to perform different functions, they still share many common features, e.g., basis shield construction and installation that are further described below.

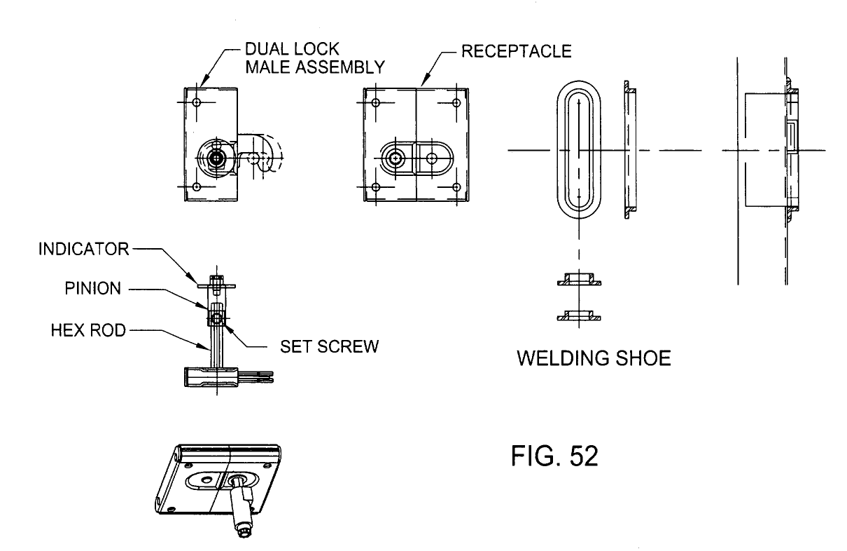

Standard shield 400 is a basic flat vertical shield with no openings. This standard shield 400 is designed to serve as the walls of the modular enclosure 110 and will likely be deployed in greater number than any other vertical shields that are described herein. Standard vertical and cap shield 400 has a plurality of latches 410 (female latches) and 420 (male latches) that are deployed on at least three sides of the vertical shields. Specifically, three male latches 420 are deployed on one side of the standard shield 400, whereas three female latches 410 are deployed on the other side of the standard shield 400. A single latch is illustrated on the top side of the vertical shield, where the latch will engage a complementary latch on a cap shield that will form a part of the ceiling. Thus, as vertical shields are aligned vertically next to each other or with a cap shield, these male-female latches are engaged to lock the shields together to form a strong and air-tight seal. The number of male-female latches that are deployed on each side of the shield is a function of the length and width of the shield. A detailed illustration of the latching system is shown in FIG. 52.

FIG. 5 illustrates a vertical carrier shield 500 of the present invention. The vertical carrier shield 500 is designed to provide a feed-through access to the modular enclosure 110, e.g., allowing cables to be passed through a vertical shield. Specifically, the vertical carrier shield 500 is similar in construction to that of the standard vertical shield 400 with the exception that it has a carrier portal 510.

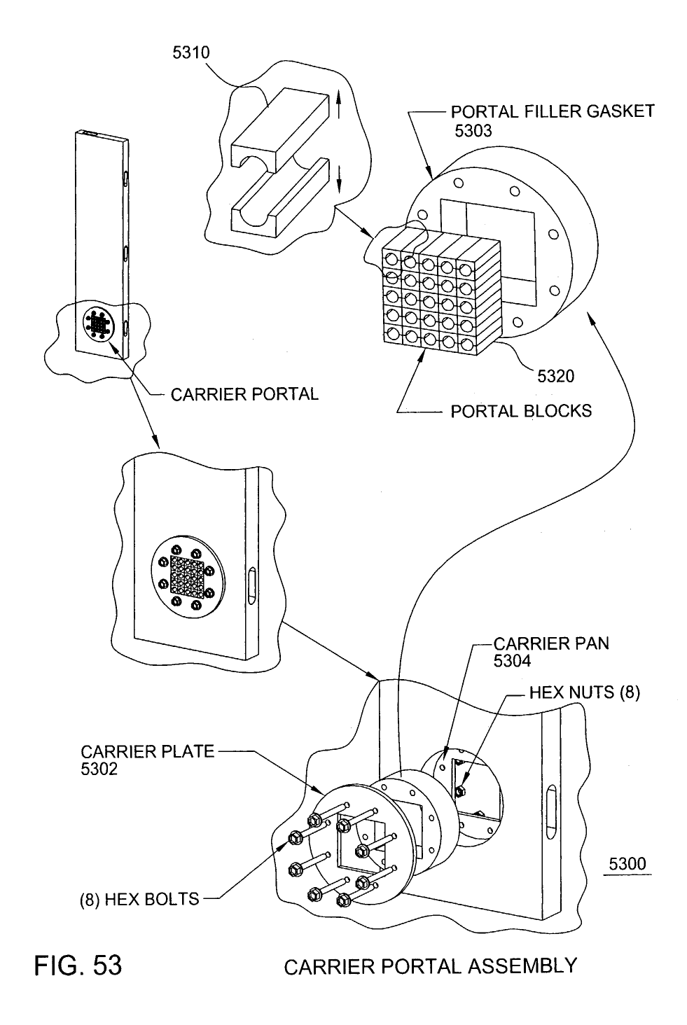

In one embodiment, the carrier portal is a circular hole assembly as shown in FIG. 53 that is designed to operate with a plurality of cable blocks or portal blocks 5310 that are deployed around cables that are passed through the carrier portal. In one embodiment, each cable is disposed or sandwiched within two halves of a cable block. In turn, these cable blocks are stacked 5320 within the carrier portal. The cable blocks are manufactured using an insulating material that is designed to expand upon exposure to heat (e.g., the same material that is used to form the gaskets between the shields as discussed below). As such, during a fire condition, the cable blocks will expand and form a tight seal within the carrier portal of the vertical carrier shield. The carrier portal assembly 5300 (carrier plate 5302, portal filler gasket 5303, carrier pan 5304) and the cable blocks 5310 are illustrated in FIG. 53.

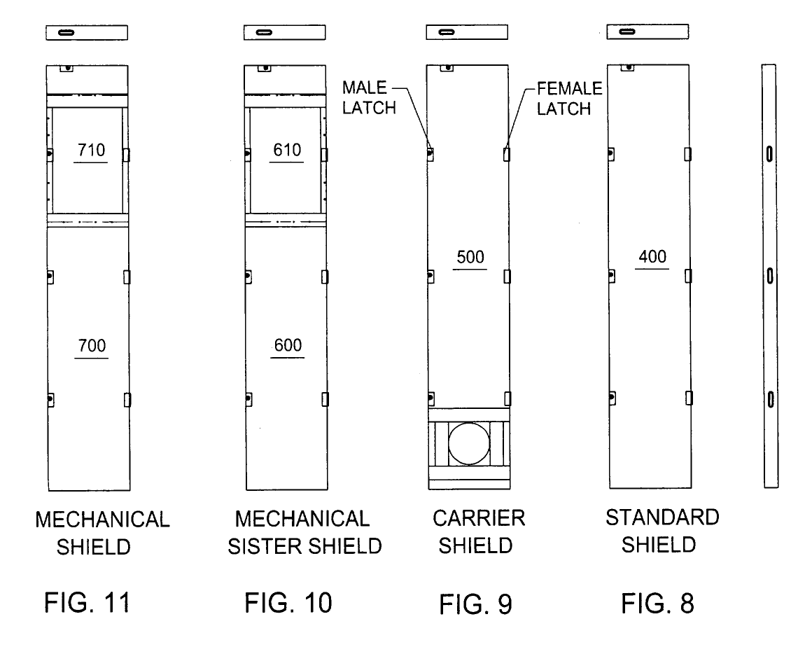

FIGS. 6 and 7 collectively illustrate a pair of vertical mechanical shields 600 and 700 of the present invention. The vertical mechanical carrier shields 600 and 700 are designed to be deployed side by side. These shields are designed to allow ducting, e.g., HVAC ducts, to be attached to the modular enclosure 110. However, due to the high degree of protection that is required by the modular enclosure in some applications, there are situations where it may be necessary to close the ducts to the modular enclosure during a hazardous condition.

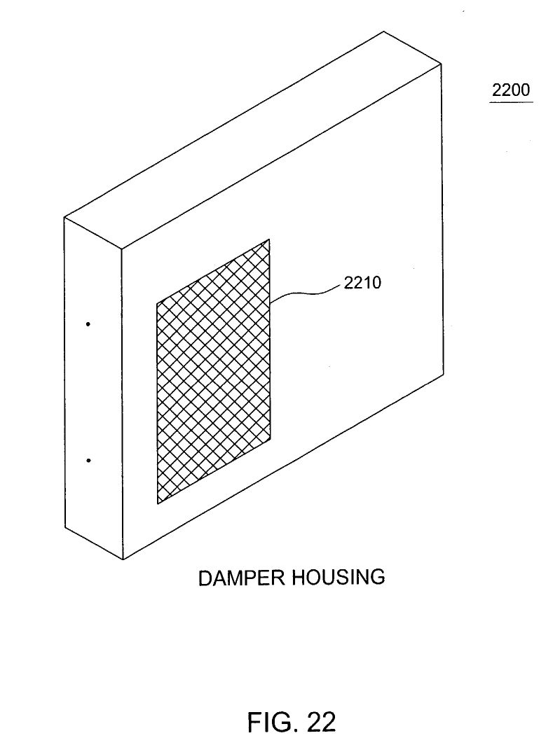

To address this criticality, the first vertical mechanical shield (or sister shield) contains a duct access aperture 610. In operation, a duct (not shown) is attached to this duct access aperture 610. In turn, a damper housing (as shown in FIG. 22 below) is attached behind the pair of mechanical shields. The mechanical damper is installed over two shields; a mechanical shield and a mechanical sister shield.

The damper housing carries a movable “damper shield” that is stored behind aperture 710 of the second vertical mechanical shield 700, where the two apertures 610 and 710 are laterally aligned. During a hazardous condition, an actuating system will cause the damper shield to slide from behind the second vertical mechanical shield 700 and onto the first vertical mechanical shield 600, thereby closing the ducting. Again, the vertical mechanical shields 600 and 700 are similar in construction to that of the standard vertical shield 400 with the exception of the duct access aperture 610 and the damper shield assembly.

FIGS. 8-11 illustrate the front and top views of a basic flat vertical shield, a carrier vertical shield, a first mechanical vertical shield, and a second mechanical vertical shield, respectively, of the present invention. A side view is also provided for the standard vertical shield 400.

In one embodiment, the vertical shields are approximately 10′2″ in height and 2′ in width. The first lowest latch is located approximately 2′ from the bottom of the vertical shield with each subsequent latch being disposed approximately 2′7″ from a lower latch.

The carrier portal 510 is disposed approximately 7″ from the bottom of the vertical carrier shield. The diameter of the carrier portal 510 is approximately 1′1″ in diameter.

The height of the duct access aperture 610 is approximately 2′7″, whereas the width of the duct access aperture 610 is approximately 1′8″. The aperture 710 is similar in size to that of duct access aperture 610.

It should be noted that the dimensions that are disclosed above for the vertical shields are only illustrative. In fact, the size, quantity and/or placement of various structures can be changed as the need arises. For example, it should be noted that although the above vertical shields are disclosed with three latches on two sides and one latch on a top side, those skilled in the art will realize that any number of latches can be deployed and it is generally a function of the length of a particular side of the shield. As such, although dimensions of numerous structures are disclosed throughout this disclosure, those skilled in the art will realize that the present invention is not so limited. Namely, the specific dimensions of these shields and their components and/or subassemblies can be tailored to meet the requirements of a particular deployment.

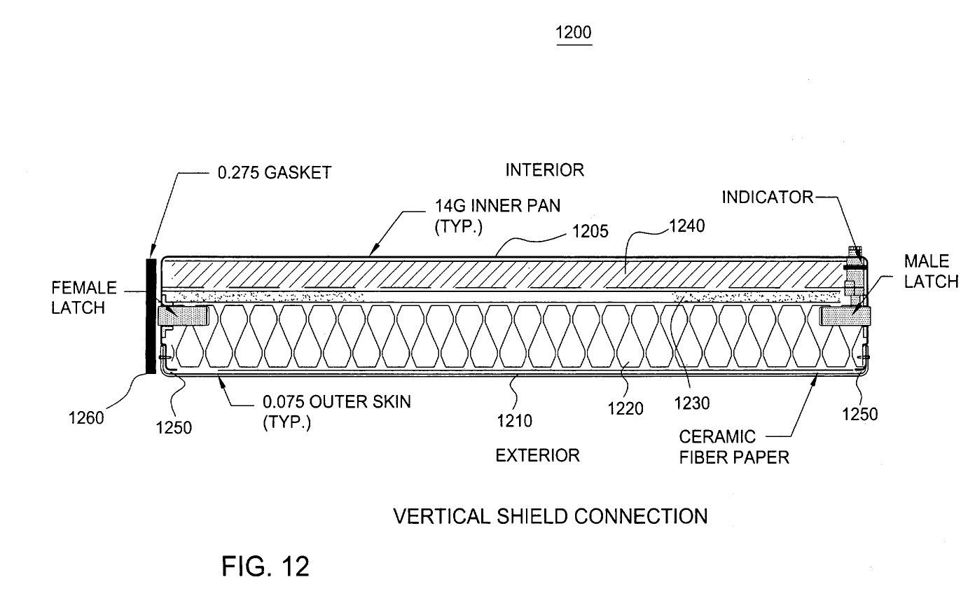

FIG. 12 illustrates a cross-sectional top view of a vertical shield 1200 of the present invention. It should also be noted that FIG. 12 also illustrates the general composition of all the shields of the present invention, unless specifically noted below.

Each shield has a housing that resembles a box with a lid. In one embodiment, the thickness of the shield is approximately 4″. More specifically, the shield housing comprises an inner pan 1205 and an outer skin 1210. Both the inner pan and the outer skin are constructed from steel, e.g., 14 gauge sheet steel. The interior of each shield has a three-layer core that comprises a milled fiber layer 1220, a gypsum board layer 1230 and a poly-isocyanurate with heat refracting layer 1240. In one embodiment, the three-layer core comprises a 21 lb. density milled fiber layer 1220 having an approximate thickness of 2⅝″, a gypsum board layer 1230 having an approximate thickness of ⅜″ and a poly-isocyanurate with heat refracting layer 1240 having an approximate thickness of 1″.

Additionally, an insulating material 1250 is disposed between the juncture of the inner pan 1205 and the outer skin 1210. In one embodiment, the insulating material is a ceramic fiber paper 1250 having an approximate thickness of ⅛″ that is compressible, e.g., being compressed down to 1/16″, upon being compressed between the inner pan 1205 and the outer skin 1210. A unique function performed by the ceramic fiber paper is its ability to minimize thermal conduction. As the outer skin of a shield is being heated, e.g., from a fire, the thermal energy can be transferred from the outer skin to the inner pan due to the ease of thermal conduction in metals. Without the ceramic fiber paper 1250, the interior pan may rapidly heat up and degrade the performance of the modular enclosure.

FIG. 12 also illustrates a novel gasket 1260 that is deployed in conjunction with the various shields of the present invention. In FIG. 12, a single gasket 1260 is shown being positioned to one side of the vertical shield 1200. However, it should be noted that a gasket 1260 is typically deployed between all adjoining shields. However, depending on the types of shields being joined, the physical size and shape of gasket 1260 may differ.

Specifically, as heat is applied to the exterior of the modular enclosure 110, it has been observed that the joints between adjoining shields may potentially be the weaker points of the overall modular enclosure. The gasket is designed to resist heat and to expand in the presence of heat, thereby preventing the breach of the protected environment of the modular enclosure 110 by potentially noxious gases. A detailed disclosure of the gasket is provided below.

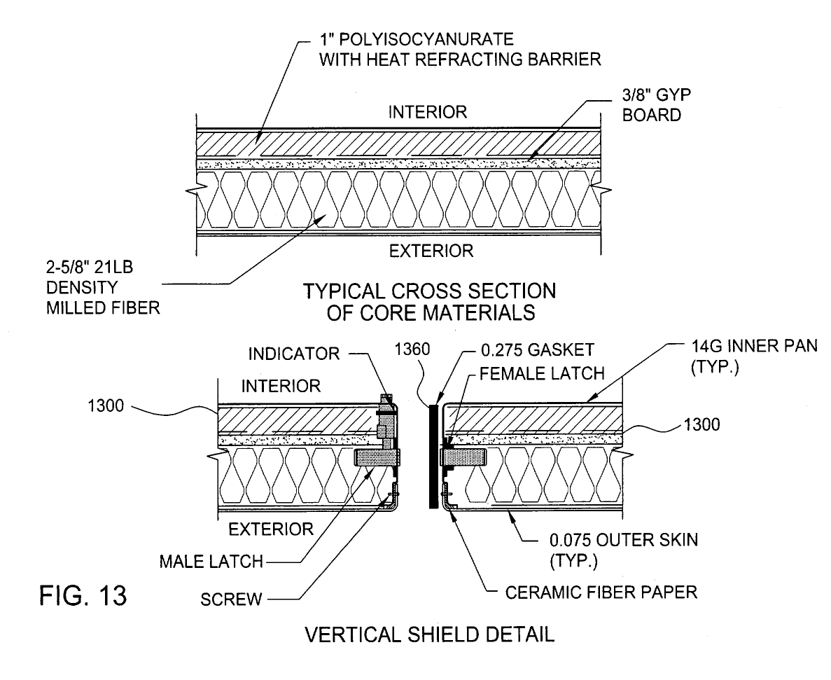

FIG. 13 illustrates a cross-sectional top view of a gasket 1360 that is disposed between two vertical shields 1300 of the present invention. The height and depth of gasket 1360 is simply tailored to match the dimensions of the adjoining shields. The width of the gasket is approximately 0.3″ in an uncompressed state. However, once the gasket is deployed between two shields, the flexible gasket compressed down to a width of approximately 0.2″.

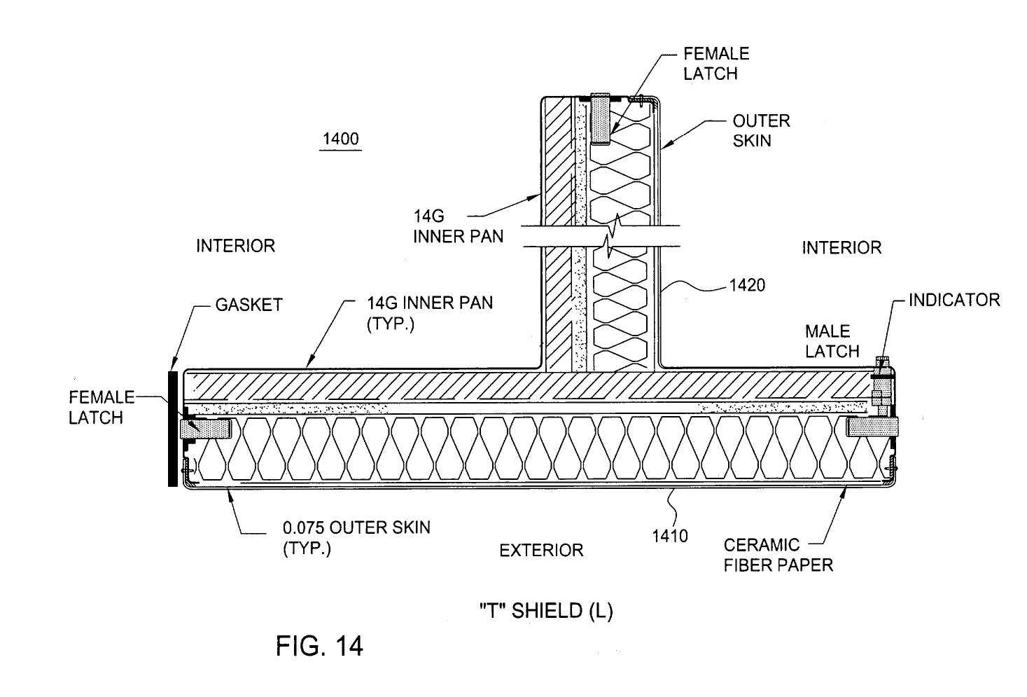

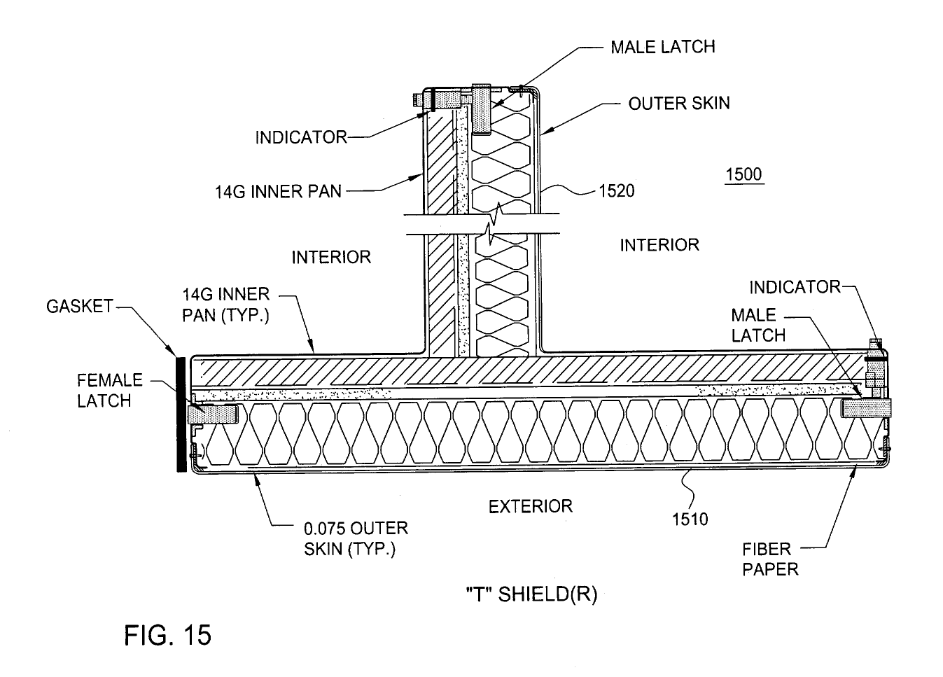

FIGS. 14 and 15 illustrate vertical T shields 1400 and 1500 of the present inventions. Vertical T shields 1400 and 1500 are similar with the exception that they are complementary in their configuration relative to each other, e.g., T shield 1400 can be perceived as a left (L) T shield, while T shield 1500 can be perceived as a right (R) T shield.

Specifically, vertical T shields 1400 and 1500 are similar to the standard vertical shields 1200 in construction. However, unlike the standard vertical shield, each vertical T shield comprises an exterior portion 1410 (or 1510) that has one side being exposed to the exterior of the modular enclosure 110 and an interior portion 1420 (or 1520) that is disposed within the modular enclosure 110 in its entirety. As illustrated in FIG. 3 above, the pair of T shields 1400 and 1500 are deployed so that interior rooms can be defined by connecting additional vertical shields to the interior portions 1420 and 1520 in similar manner as described above.

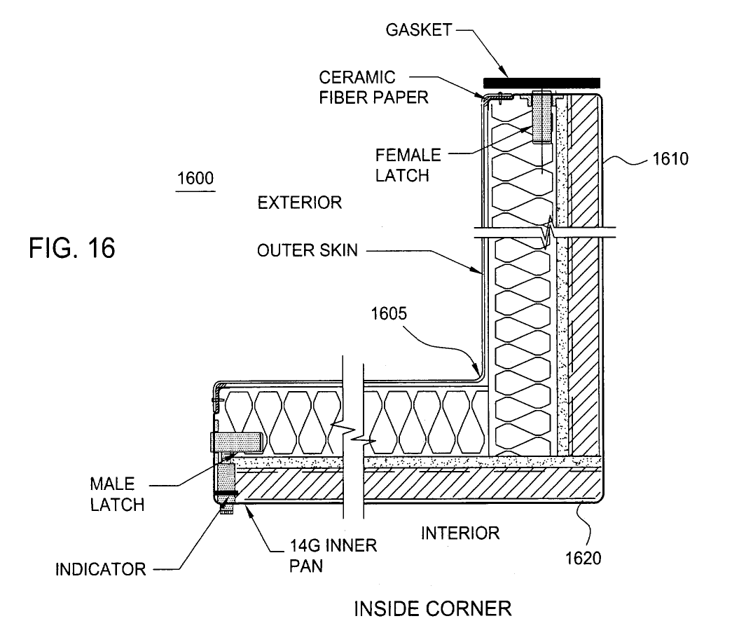

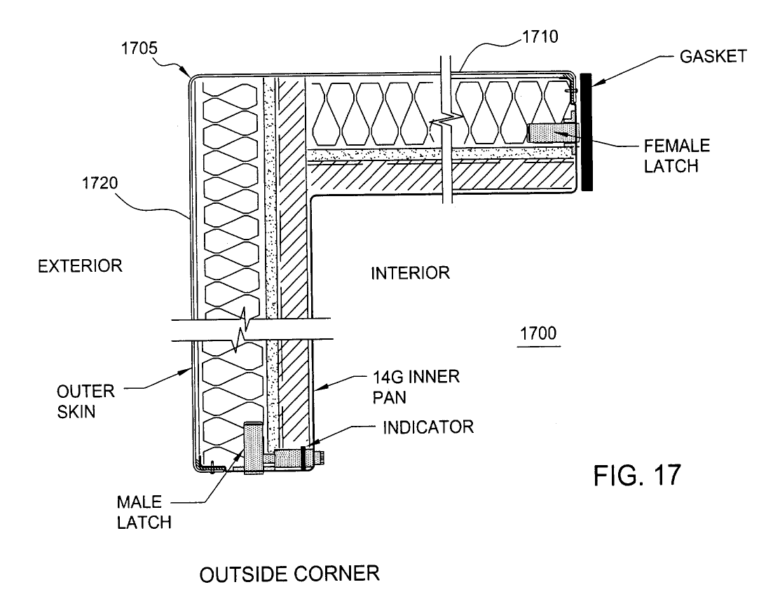

FIGS. 16 and 17 illustrate a cross-sectional top view of an inside corner vertical shield 1600 and an outside corner vertical shield 1700, respectively, of the present invention. Inside corner vertical shield 1600 and the outside corner vertical shield 1700 are similar with the exception that they are opposite in their configuration relative to each other. For example, inside corner vertical shield 1600 provides a concave corner 1605 from a perspective outside of the modular enclosure 110, whereas outside corner vertical shield 1700 provides a convex corner 1705 from a perspective outside of the modular enclosure 110.

Again, the inside corner vertical shield 1600 and the outside corner vertical shield 1700 are similar to the standard vertical shields 1200 in construction. However, unlike the standard vertical shield, each inside or outside corner vertical shield comprises two portions 1610 and 1620 or 1710 and 1720 that are connected at a right angle in one embodiment of the present invention. However, although the present corner vertical shields are disclosed as having two portions that are joined at right angles, those skilled in the art will realize that these two portions can be joined at other angles as required by a particular deployment.

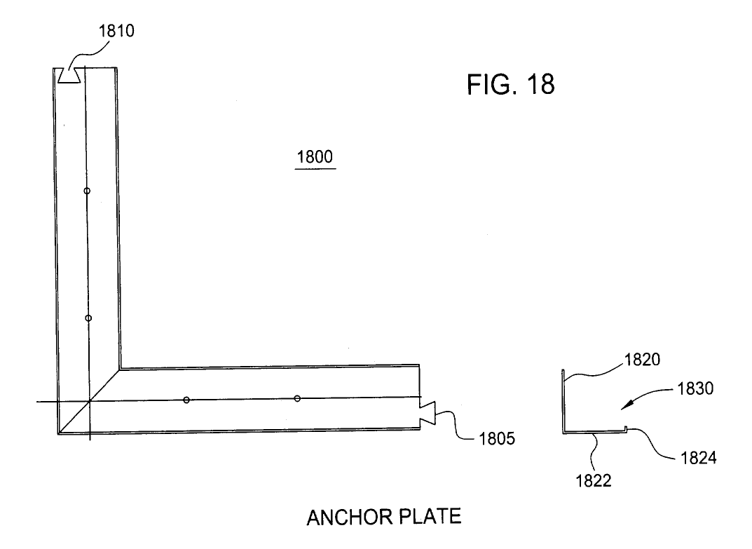

FIG. 18 illustrates an anchor plate 1800 of the present invention. More specifically, FIG. 18 illustrates a top and side view of a corner anchor plate 1800. In one embodiment, each side of the corner anchor plate 1800 is approximately 2′ long. Anchor plates are deployed throughout the perimeter of the modular enclosure to serve as anchoring platform to receive various vertical shields. In the construction of a modular enclosure 110, anchor plates are initially mounted to the floor of a facility before the vertical shields can be deployed. A plurality of anchor plates are coupled together using tongue 1805 and groove 1810 slots that are disposed on opposite ends of each anchor plate. Thus, if a rectangular modular enclosure is desired, four corner anchor plates 1800 are deployed with any number of straight anchor plates (not shown) to form a perimeter of anchor plates.

The anchor plate 1800 is constructed from ⅛″ steel plate. Each anchor plate has a trough 1830 that is defined by an exterior lip 1820, a bottom member 1822 and an interior lip 1824. In one embodiment, exterior lip 1820, bottom member 1822 and interior lip 1824 are approximately 4″, 4″ and ⅜″ in length, respectively.

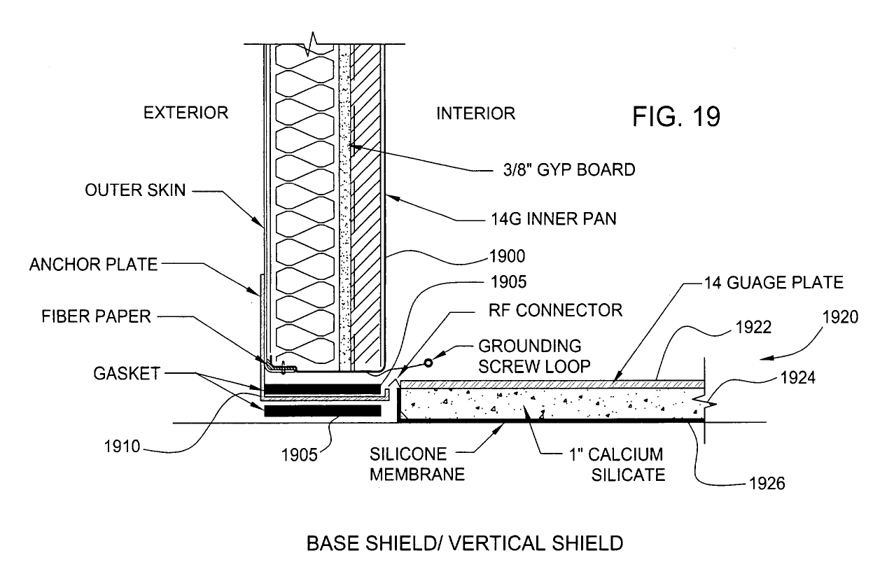

FIG. 19 illustrates a cross-sectional side view of the placement of a base shield 1920 relative to a vertical shield 1900. More specifically, FIG. 19 illustrates the joining of the vertical shield to the anchor plate and the base shield 1920. In one embodiment, gaskets 1905 are deployed above and below the anchor plate 1910. The use of gaskets 1905 in this novel configuration provides superior insulating properties because both junctures: vertical shield to anchor plate and anchor plate to the floor are insulated with gaskets 1905. Once the gaskets 1905 and anchor plate 1910 are secured to the floor of the facility, the vertical shield 1900 is mounted to the anchor plate 1910 with the exterior lip 1820 of the anchor plate being exterior to the modular enclosure.

In turn, the base shield 1920 is installed on the floor of the building and it abuts the vertical shield 1900. A plurality of base shields are deployed to form the floor of the modular enclosure 110. In one embodiment, the base shield 1920 comprises a silicon membrane exterior 1926 that is filled with calcium silicate 1924 and is topped with a 14 gauge steel plate 1922.

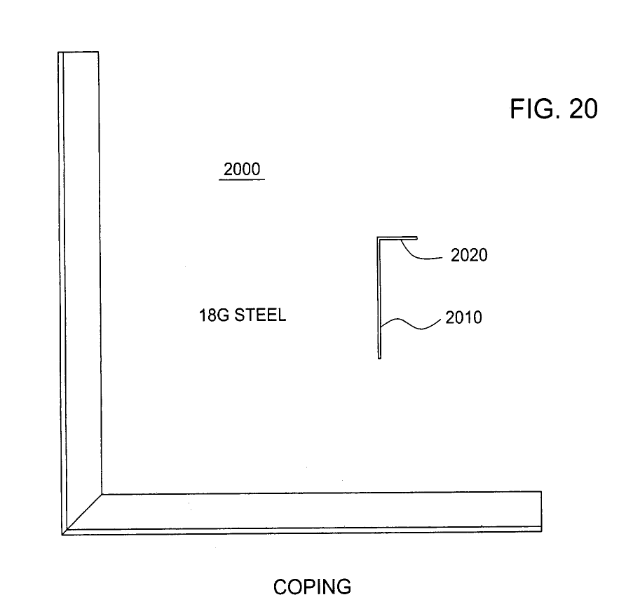

FIG. 20 illustrates a coping 2000 of the present invention. More specifically, FIG. 20 illustrates a top and side view of a corner coping 2000. In one embodiment, each side of the corner coping 2000 is approximately 2′ long. Copings are deployed throughout the upper perimeter of the modular enclosure to serve as a covering to cover junctures between the vertical shields and the cap shields. In the construction of a modular enclosure 110, copings are mounted to the ceiling of a facility after the vertical shields are joined with the cap shields. Thus, if a rectangular modular enclosure is desired, four corner copings 2000 are deployed with any number of straight copings (not shown) to form a upper perimeter of copings.

The coping 2000 is constructed from 18 gauge steel plate. Each coping has an exterior lip 2010, and a top member 2020. In one embodiment, exterior lip 2010 is approximately 6″ in length, whereas the top member 2020 is approximately 2″ in length.

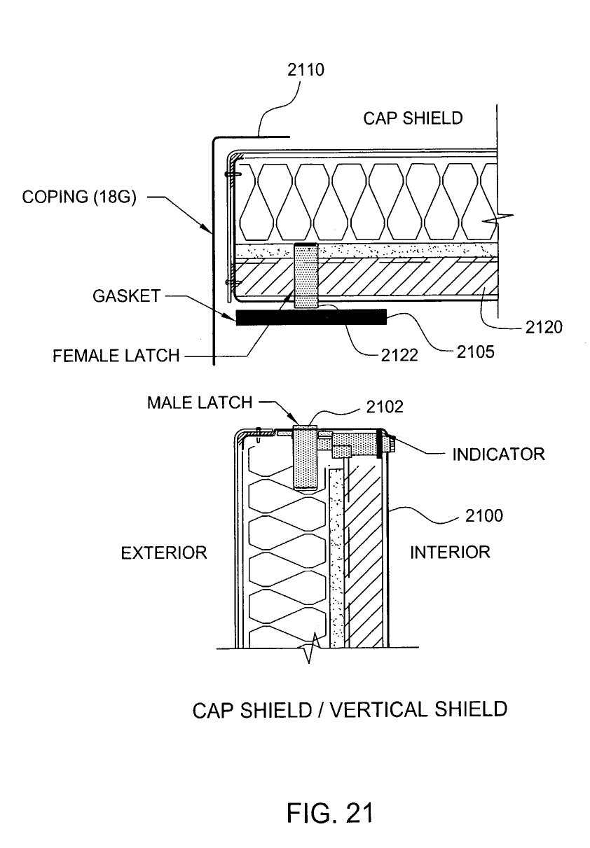

FIG. 21 illustrates a cross-sectional side view of the placement of a cap shield 2120 relative to a vertical shield 2100. More specifically, FIG. 21 illustrates the joining of the vertical shield to the coping and the cap shield 2120. In one embodiment, gasket 2105 is deployed between the vertical shield 2100 and cap shield 2120. Once the vertical shield 2100 is mounted to the anchor plate, the gasket 2105 and cap shield 2120 are joined with the vertical shield 2100 via male 2102 and female 2122 latches. Finally, coping 2110 is mounted to cover the juncture between the cap shield 2120 and the vertical shield 2100.

In turn, a plurality of cap shields are deployed to form the ceiling of the modular enclosure 110. In one embodiment, the composition of a cap shield 2120 is identical to that of a standard vertical shield.

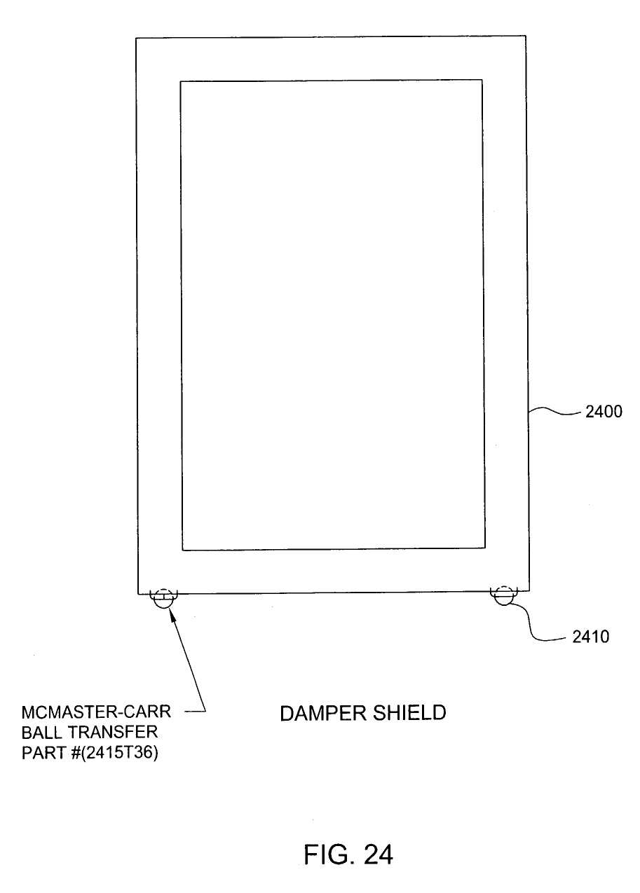

FIG. 22 illustrates an isometric view of a damper housing 2200 of the present invention. The damper housing 2200 is mounted behind the two mechanical shields 600 and 700 of FIGS. 6 and 7. The damper housing 2200 carries a damper shield (as shown in FIGS. 24-26) that is designed to slide over and close the duct access aperture 610 during a hazardous condition. More specifically, the damper housing 2200 has an access aperture 2210 that is aligned with the access aperture 610 of vertical mechanical shield 600.

In one embodiment, the damper housing 2200 is approximately 46″ in width, 39″ in height, and 8″ in depth. The damper housing is constructed from 11 gauge steel.

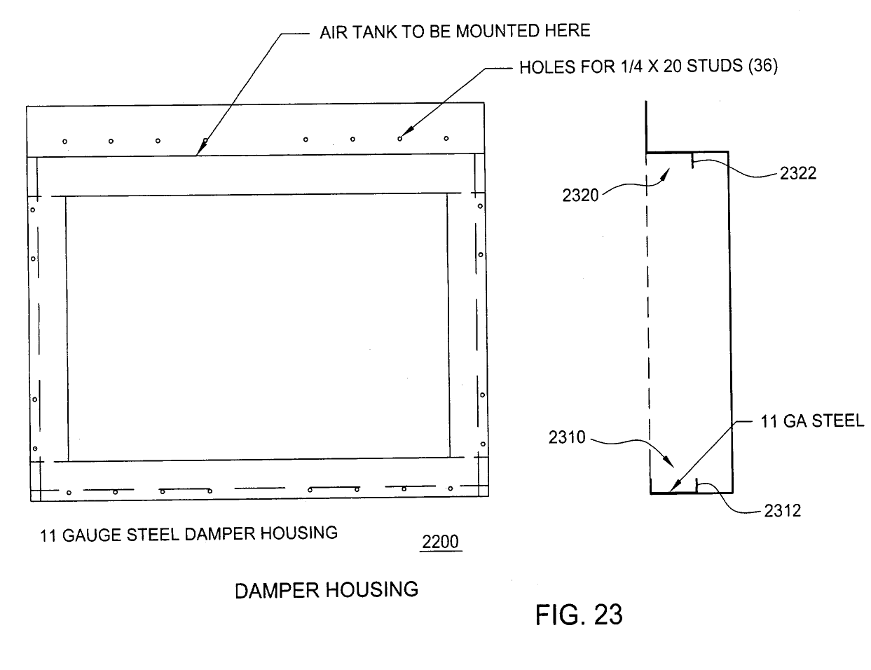

FIG. 23 illustrates a front view and a side view of the damper housing 2200 of the present invention. The damper housing 2200 contains an upper guide 2320 and a lower guide 2310 that assist the damper shield to slide laterally to an “open” or “closed” position. Both guides contain a lip 2322 and 2312, respective, to keep the damper shield properly aligned as it traverses between the “open” and “closed” positions.

FIG. 24 illustrates a front view of a damper shield 2400 of the present invention. In operation, damper shield 2400 is stored within the damper housing 2200. If a hazardous condition is detected, the damper shield 2400 is deployed such that it slides across and seals off the access aperture 610 of the vertical mechanical sister shield 600 of FIG. 6.

In one embodiment, the damper shield 2400 is approximately 2′8″ in height, 1′10″ in width and 4″ in depth. The damper shield 2400 further comprises a pair of rollers or ball transfers 2410, e.g., from McMaster-Carr with part # (2415T36).

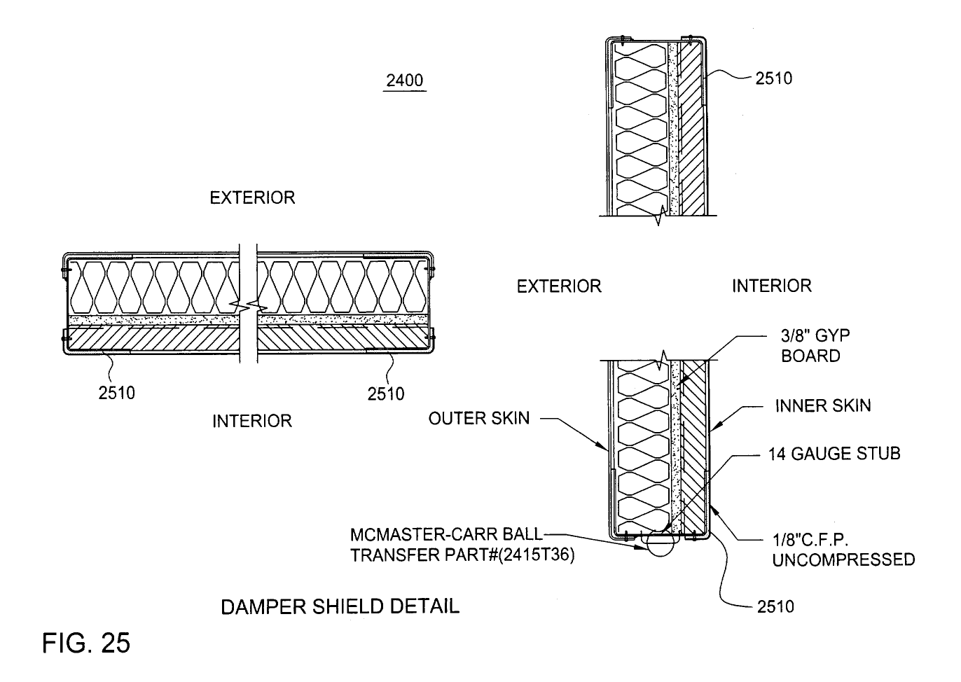

FIG. 25 illustrates a cross-sectional top and side views of the damper shield 2400 of the present invention. The damper shield construction is similar to that of the standard vertical shield 1200. Namely, the damper shield 2400 shares the same core as that of the standard vertical shield 1200. However, since the damper shield 2400 is a movable shield, there are no male and female latches deployed on the damper shield 2400. Additionally, the damper shield 2400 employs an additional layer of ceramic fiber paper 2510 on the interior periphery of the damper shield 2400. This additional layer of ceramic fiber paper 2510 reduces thermal conduction and also assists in providing an air tight seal when the damper shield 2400 is deployed to the closed position.

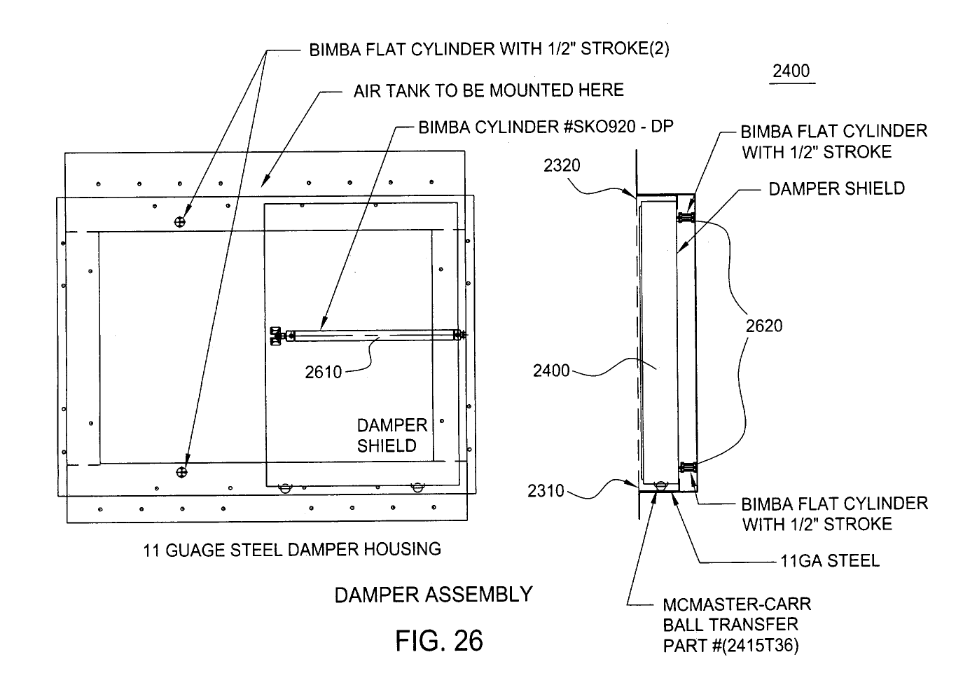

FIG. 26 illustrates a back view and a side view of the damper shield 2400 with additional subassemblies. Specifically, FIG. 26 shows a telescopic cylinder 2610, e.g., from Bimba with a part number of SK0920-DP, that is coupled to a solenoid (not shown) and to the back of the damper shield 2400. When the solenoid is activated in response to a control signal, the telescopic cylinder 2610 extends and causes the damper shield 2400 to slide along the guides 2320 and 2310. When the damper shield 2400 comes to a stop at the closed position, a pair of cylinders 2620 are activated to cause pins to bias against the back of the damper shield, thereby ensuring an air-tight seal.

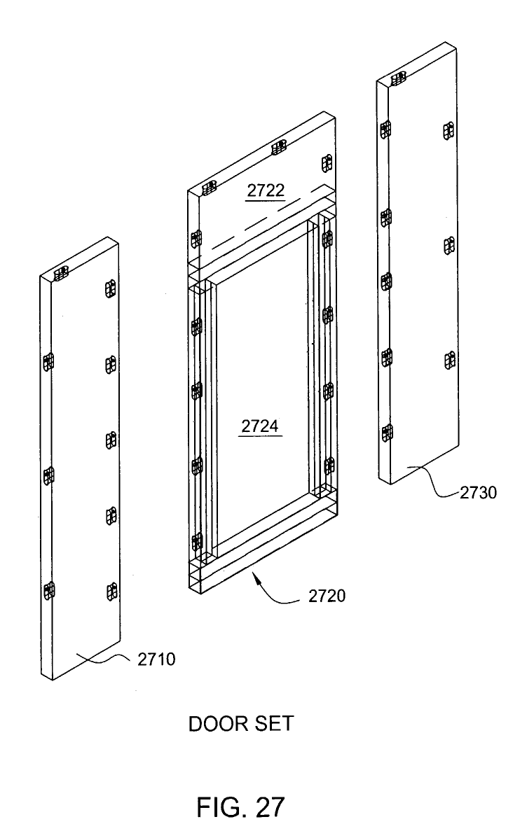

FIG. 27 illustrates an isometric drawing of a door set 2700 of vertical door shields 2710, 2720, and 2730 of the present invention. Specifically, the door set comprises a pair of complementary or sister vertical door shields 2710 and 2730 and a door shield 2720. As shown in FIG. 27, the door shield 2720 is disposed between the two sister vertical door shields 2710 and 2730. Each of the three vertical door shields is similar in construction to that of the standard vertical shield 1200. Namely, each door shield shares the same core as that of the standard vertical shield 1200. However, as shown in FIG. 27, each of the door shield employs a greater number of latch assemblies or “cam lock” assemblies that the standard shields. In one embodiment, each of the sister door shields employs three latch assemblies (male or female) on one side and five latch assemblies (male or female) of the opposite side, whereas the door shield 2720 employs five latch assemblies (male or female) on both sides. The increase in the number of latch assemblies is in response to the need to reinforce the door assembly due to the stress generated by repetitive opening and closing of the door.

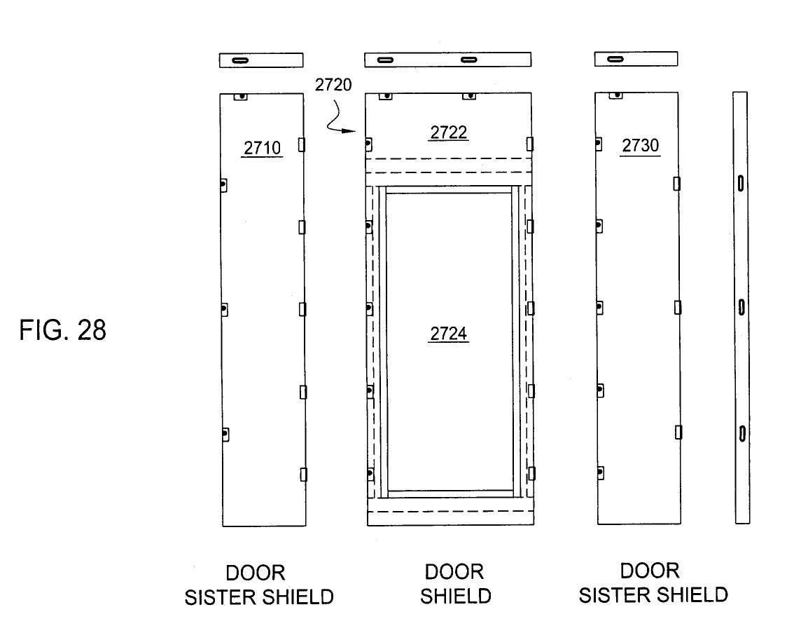

FIG. 28 illustrates a front view and a top view for each of the vertical door shields 2710, 2720, and 2730 of the present invention. Additionally, a side view is provided for vertical sister door shield 2730. In one embodiment, each of vertical sister door shields 2710 and 2730 is approximately 10′2″ in height, 2′ in width and 4″ in depth. The door shield 2720 is approximately 10′2″ in height, 3′12″ in width and 4″ in depth.

The door shield 2720 comprises two distinct portions: a door frame 2722 and a door 2724. Structures surrounding the door 2724 are specifically designed to ensure an air-tight seal and to provide superior performance under hazardous conditions such as a fire. These structures are disclosed below.

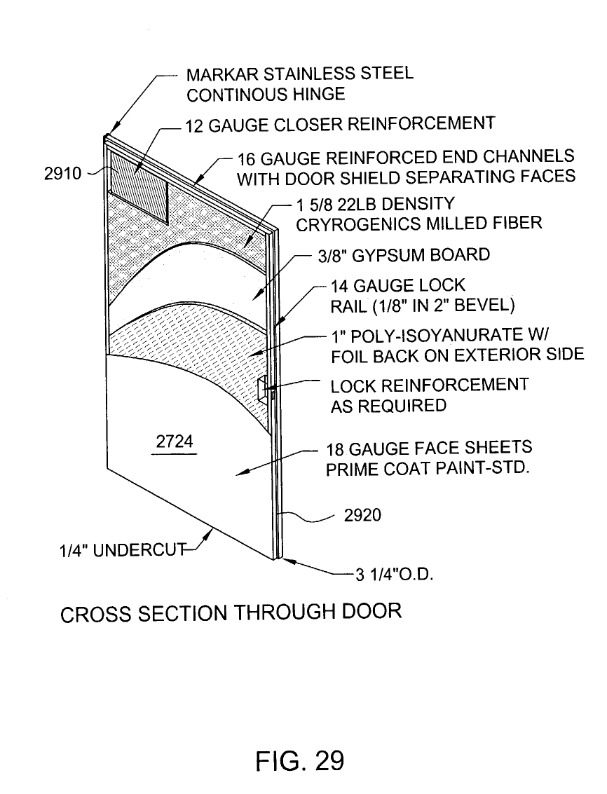

FIG. 29 illustrates an isometric cross section of the door 2724 of the present invention. Specifically, FIG. 29 again illustrates a cut-away view of the door having a core that is similar to that of the standard vertical shield. In one embodiment, the door 2724 has a different thickness or depth than a standard door shield. As such, the thickness of the core, i.e., the thickness of its components are also different as well, e.g., using 1⅝″ of 22 lb. density cryogenics milled fiber, ⅜″ of gypsum board and 1″ of poly-isoyanurate with foil back.

Additionally, unlike the vertical standard shield, the door 2724 comprises additional structures that are deployed to strengthen the structural integrity of the door. For example, the door also employs a 12 gauge closer reinforcement 2910 within the door.

Finally, the door 2724 incorporates edge or end channels 2920 (e.g., top, side or bottom channels) along the periphery of the door. These channels are designed to mate with complementary edge channels located on the door frame 2722 to form a tortuous path. Namely, when the door 2724 is closed, the coupled channels create a “step-like” air-tight path that is very difficult to breach by noxious gas.

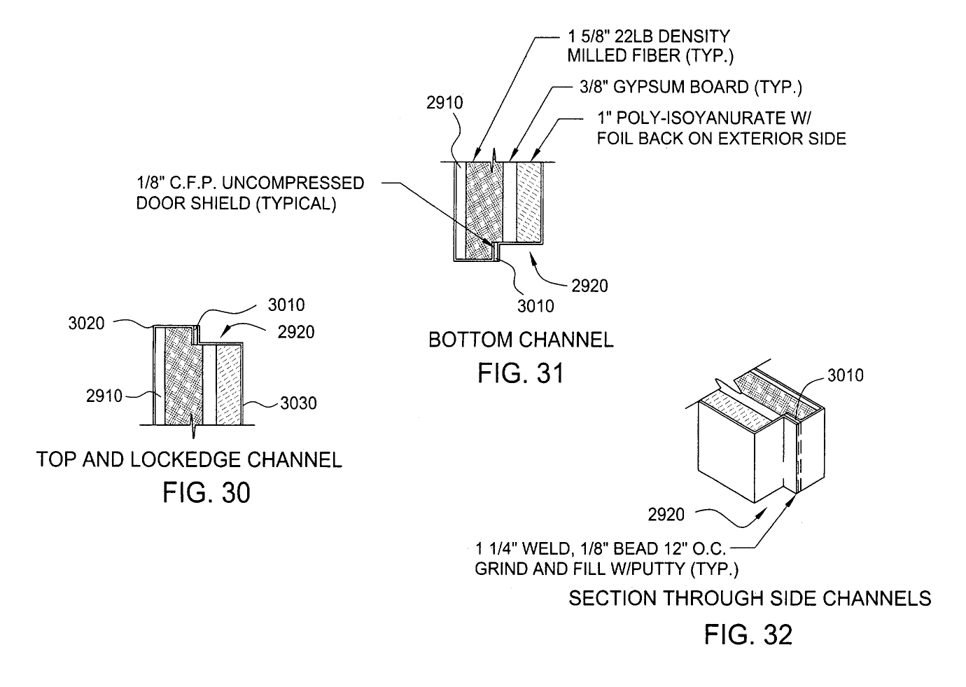

FIGS. 30-32 illustrate the top, bottom and side views of end channels 2920 surrounding the periphery of the door 2724 of the present invention. Specifically, the end channel resembles an indentation (e.g., approximately ⅝″) that runs along the entire periphery of the door 2724. The function of these end channels 2920 is best understood when described in conjunction with the door frame below.

FIGS. 30-32 also illustrate the use of ceramic fiber paper 3010 disposed between the outer 3020 and inner 3030 skin or pan of the door 2724. Again, the ceramic fiber paper 3010 serves to minimize thermal conduction such that heat applied to the outer skin of the door would not be transferred to the inner skin of the door.

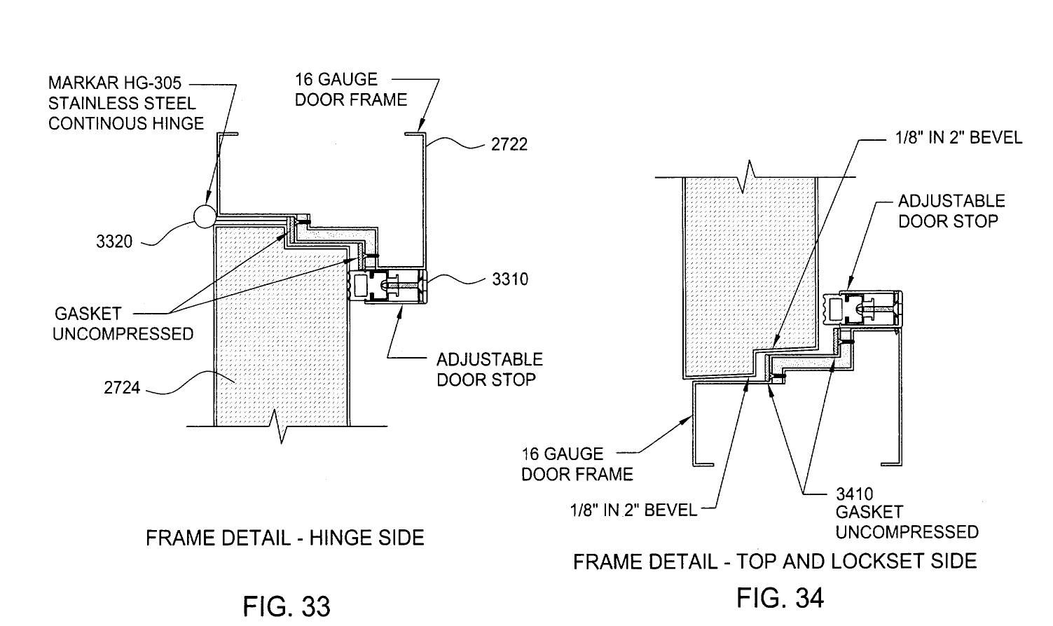

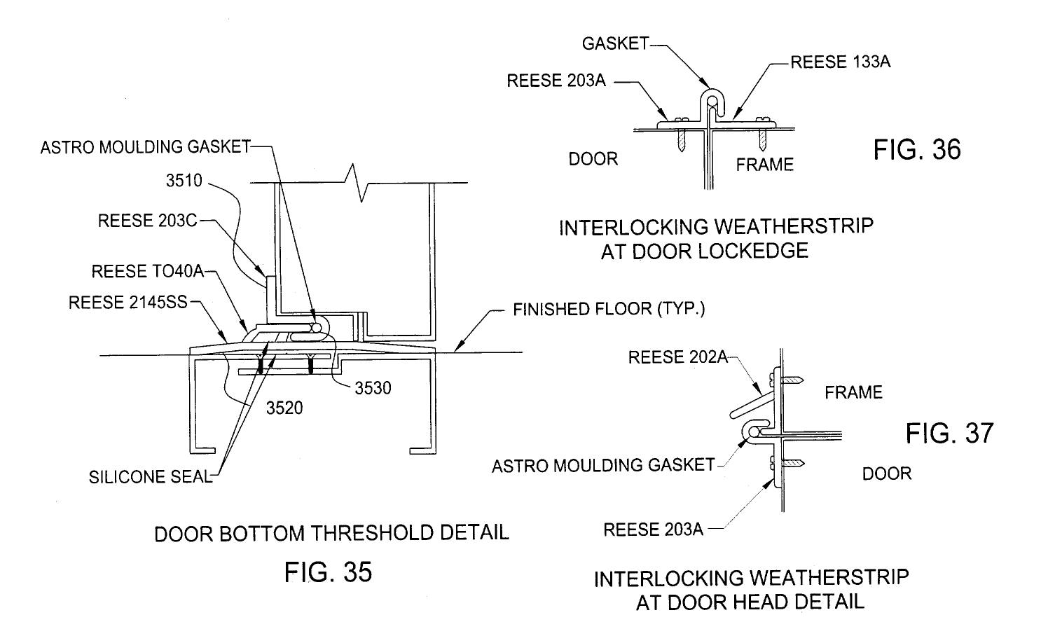

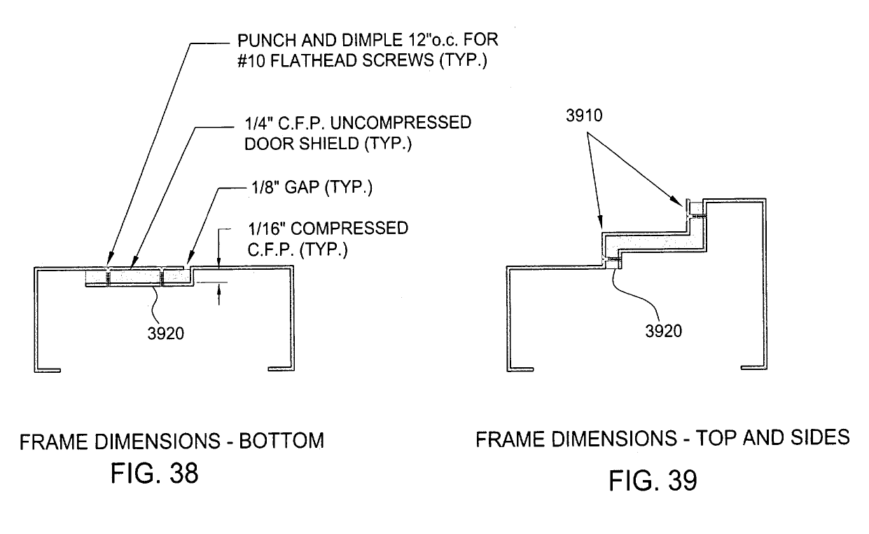

FIGS. 33-39 illustrate various cross-sectional views of the door 2724 engaging the door frame 2722. These various views illustrate various coupling structures that are deployed along the periphery of the door to ensure an air-tight seal when the door is closed. The reader is encouraged to refer to these FIGS. when reading the present description.

First, the top and sides of the door frame 2722 provide a plurality of steps 3910 for forming a tortuous path when coupled with the door 2724. This can be seen in FIGS. 34 and 39. Namely, gases that are exterior to the modular enclosure must overcome at least two right angle turns before they are able to penetrate into the interior of the modular enclosure. Additionally, to further enhance this tortuous path, gaskets 3410 are deployed along one side of the steps 3910 (See FIG. 34). Finally, again the inner and outer skins or pans of the door frame is separated by a layer of ceramic fiber paper 3920 to minimize thermal conduction.

Second, interlocking weatherstrips are provided at the door lockedge and at the door head. This can be seen on FIGS. 36 and 37. The interlocking weatherstrips are made with the same material formulation as the gaskets.

Third, a bottom portion of the door frame 2722 is provided with a tongue and groove assembly. Specifically, a tongue 3510 is mounted onto the door, whereas a groove 3520 is mounted on the bottom portion of the door frame 2722. Additionally, a thin gasket 3530 is disposed in a trough located on the tongue 3510, such that when the door is closed, the tongue 3510 engages against the groove 3520 by compressing on the thin gasket 3530. This structure again ensures an air-tight seal when the door is closed.

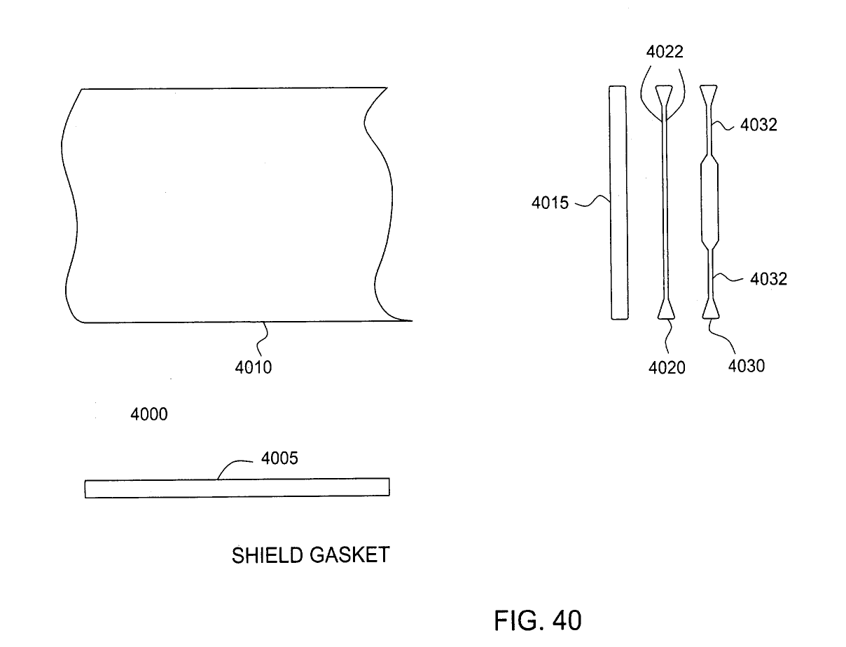

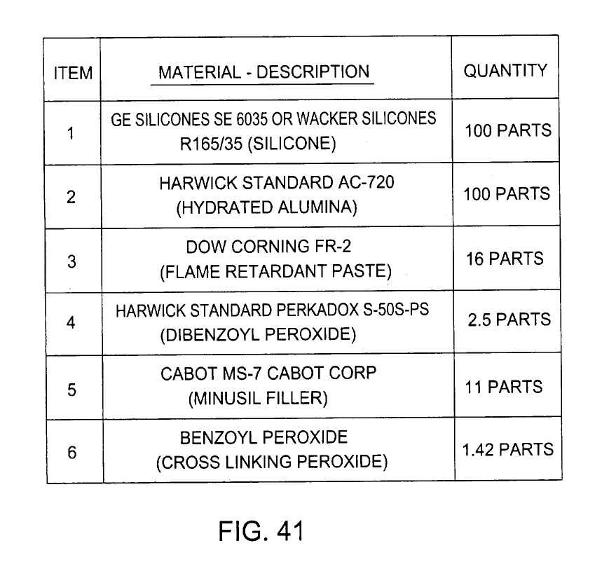

FIG. 40 illustrates a front view, a top view and a side view of the gasket 4000 of the present invention. In one embodiment, the gasket has a thickness of approximately 0.3″, and a width of approximately 3.8″. The length of the gasket is tailored to a particular length as required.

In one embodiment, the gasket 4000 is formed into a long sheet having a rectangular structure as shown in side view 4015. Alternatively, the gasket 4000 can be formed such that there is a slight indentation or depression 4022 on two sides of the gasket as shown in side view 4020. These indentations assist the insulating function performed by the gasket when it is compressed between two adjoining shields. Alternatively, the gasket 4000 can be formed such that there are two or more slight indentations or depressions 4032 on each side of the gasket as shown in side view 4030. It should be noted that these indentations are exaggerated in FIG. 40 for reader appreciation.

In one embodiment, the formulation of the gasket material is shown in FIG. 41 as a table. FIG. 41 illustrates a gasket formulation that comprises 6 components: silicon compound, hydrated alumina filler, flame retardant ingredient, Di Benzoyl Peroxide, Minusil filler and Cross linking Peroxide. When applicable, FIG. 41 also provides specific manufacturers that carry these materials under their trade names. However, those skilled in the art will realize that equivalent materials from other manufacturers can be substituted. Furthermore, although FIG. 41 provides a specific formulation in terms of approximate proportions, those skilled in the art will realize that slight modification from the disclosed formulation will produce a gasket having similar properties.

The mixing procedure for the gasket material 4000 is as follows:

1) Put SE6035 on mill with a ½ inch gap. Allow to break down and warm up for 2 minutes.

2) Slowly add FR-2, AC-720, Cabot MS-7, HCC3144 black, Perkadox S-50S-PS and Benzyl peroxide.

3) Sweep pan and return the ingredients back into the batch.

4) Once all the ingredients are absorbed by the silicone begin mixing.

5) Roll the material up and mix end until all the ingredients are blended homogeneously throughout the batch.

6) Verify the batch is mixed properly by the use of an oscillating disc rheometer or equivalent.

7) Package material in a manner as not to allow contamination of the material from outside sources.

It should be noted the above mixing procedure is provided only as an example. Other mixing procedures can be deployed using the formulation disclosed on FIG. 41 to form the gasket of the present invention.

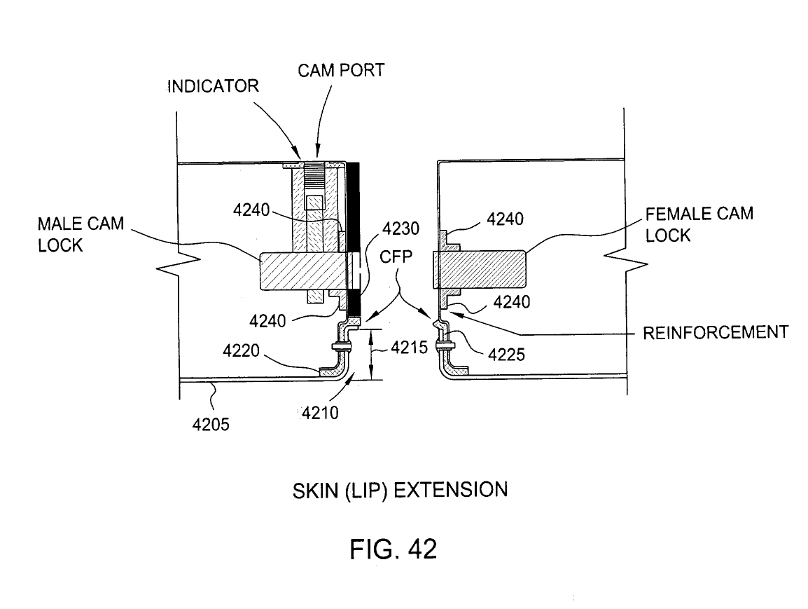

FIG. 42 illustrates an alternate structure for shields of the present invention. Specifically, FIG. 42 illustrates an outer skin of a shield having a protruding flange 4210, e.g., approximately 0.2″. Additionally, the ceramic fiber paper 4220 is extended such that a portion extends and covers the gasket 4230. This extension is similarly applied to the outer skin 4205 such that it, in turn, covers the extended portion of the ceramic fiber paper 4220. A similar extension can be provided on the adjoining shield, where only the ceramic fiber paper 4225 is also extended. This alternate configuration may provide additional insulating properties, because the gasket 4230 is further shielded from a direct hazardous condition, e.g., heat and fire.

Additionally, FIG. 42 also shows an indentation 4215 in the outer skin, where the gasket edge is recessed from the outer surface of the shield. This structure again minimizes the direct exposure of the gasket to hazardous conditions.

Furthermore, FIG. 42 also illustrates the use of additional reinforcement or edge stiffeners 4240 on the side of the shields. These stiffeners can be deployed to ensure that when the male/female latches are engaged, uniform pressure is applied along the entire length of the shields. Namely, if the shield is very long and the male/female latches are deployed in wide intervals, then it may be necessary to stiffen the sides of shields to ensure that the air-tight seal is maintained.

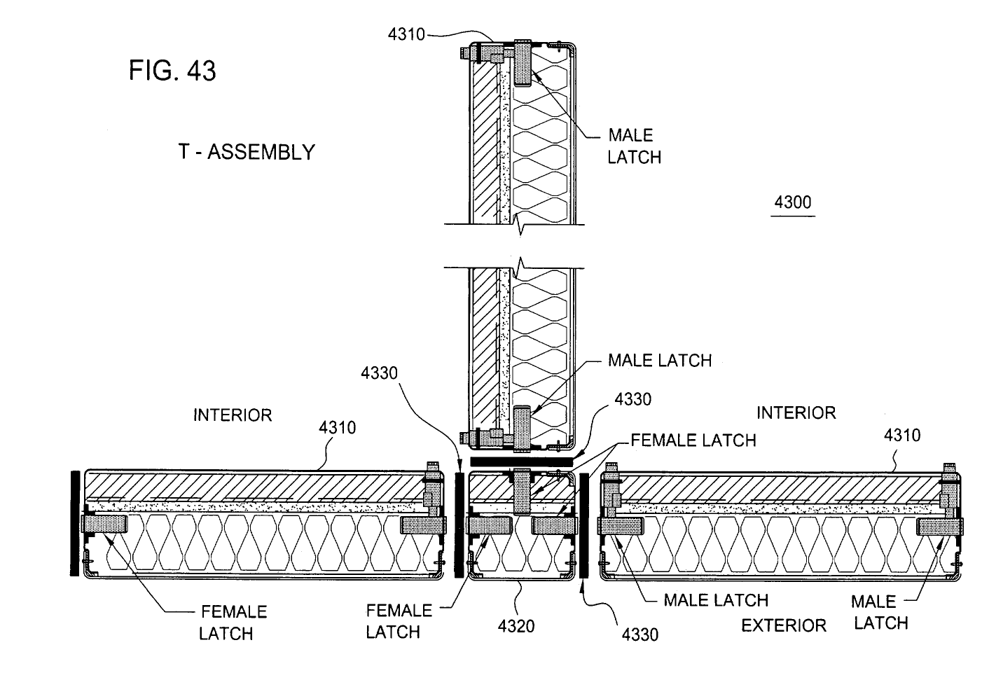

FIG. 43 illustrates an alternate T-assembly or T-shield 4300 of the present invention. More specifically, FIG. 43 illustrates an alternate embodiment in forming a T-shield as disclosed above. In this embodiment, the T-shield 4300 is formed using three standard vertical shields 4310 and a post 4320. One advantage of this embodiment is its ease of installation, since the four pieces can be handled individually, without having to install a fully assembled T-shield which can be unwieldy. The post 4320 is comprised of a pan and skin as disclosed above with the exception that the core is not a three-layer core. Instead, the core of the post 4320 is comprised of milled fiber only. Since the shields are 4″ thick in one embodiment, the post 4320 is also 4″ by 4″ of any desired height.

Additionally, unlike other shields, the post 4320 deploys only female latches such that it can be mated with male latches from three standard vertical shields 4310. Finally, gaskets 4330 are deployed at the junctures where the three standard shields are mated to the post 4320.

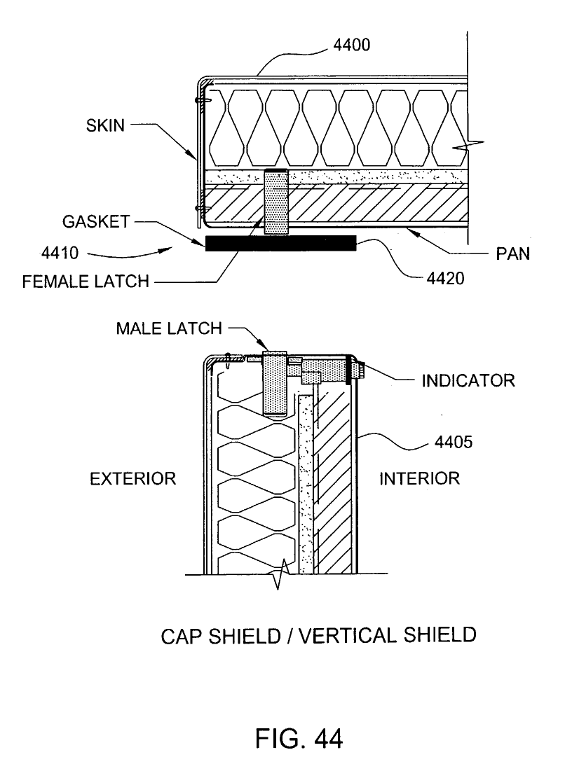

FIG. 44 illustrates an alternate structure for a cap shield of the present invention. Specifically, FIG. 44 illustrates an outer skin of a cap shield 4400 having a protruding flange 4410. The purpose of this protruding flange 4410 serves the same function as discussed in FIG. 42. Namely, the protruding flange 4410 will further protect the gasket 4420 that is disposed between the cap shield 4400 and the vertical shield 4405.

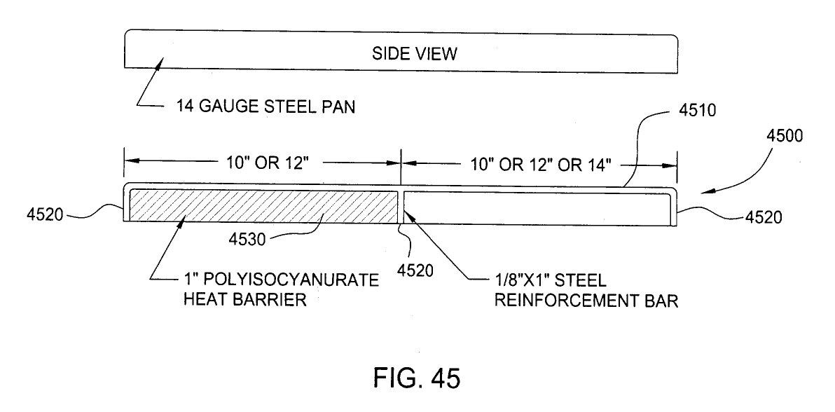

FIG. 45 illustrates an alternate base shield 4500 of the present invention. Specifically, the base shield 4500 is not deployed in a pan and skin configuration. Instead, the base shield 4500 now comprises a top surface 4510 that is supported by a plurality of steel reinforcement bars 4520, where poly-isocyanurate 4530 is deposited below the top surface 4510. The top surface and reinforcement bars are formed from 14 gauge steel in one embodiment. In practice, a sealant is typically sprayed onto the floor of the facility before the base shield is deployed. One advantage of this alternate base shield is that it is lighter than the above disclosed base shield and thus, simplifies the installation process.

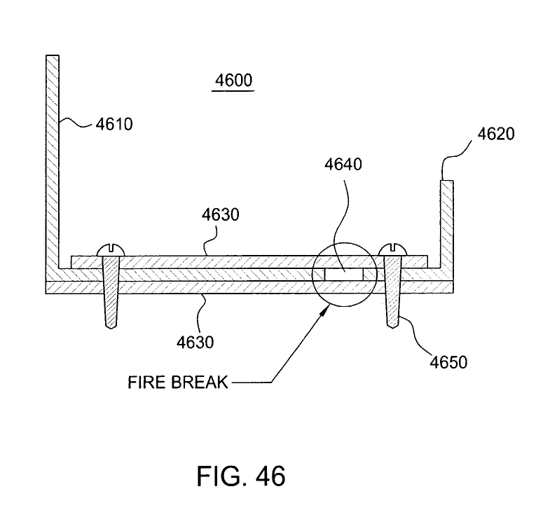

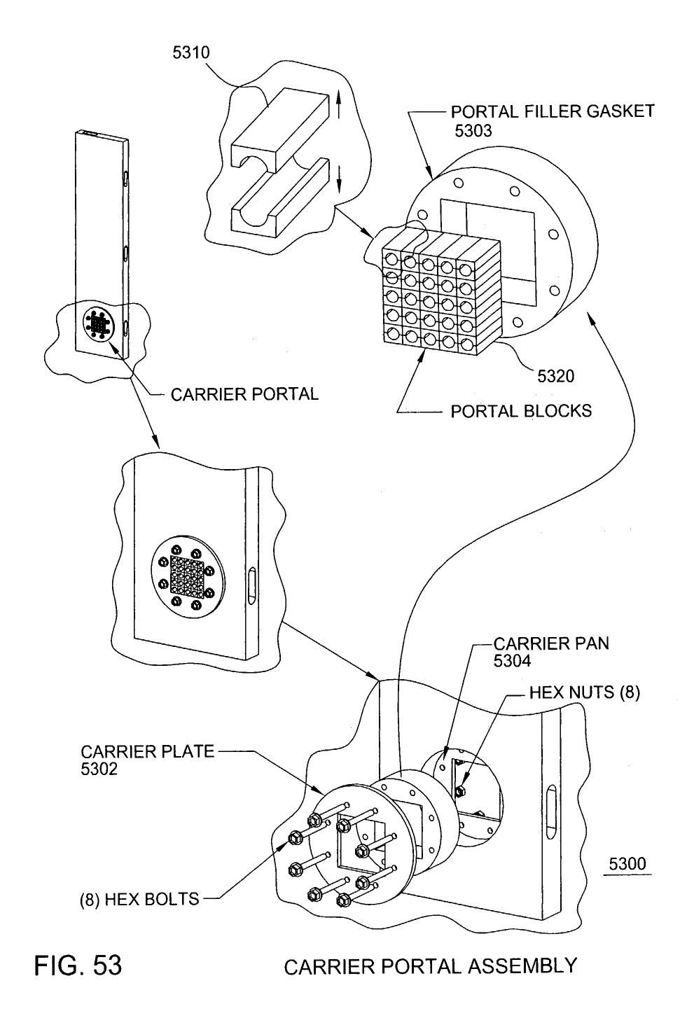

FIG. 46 illustrates an alternate anchor plate 4600 of the present invention. Specifically, anchor plate 4600 is now deployed as an assembly having two separate portions: a front angled portion 4610 and a back angled portion 4620. In contrast to the above described anchor plate, the present alternate anchor plate 4600 has an air gap 4640 separating the two angled portions, thereby minimizing thermal conduction at the anchor plate. Similar to the above embodiment, gaskets 4630 are deployed above and below the anchor plate assembly, with anchor screws 4650, being deployed to hold the anchor assembly in place.

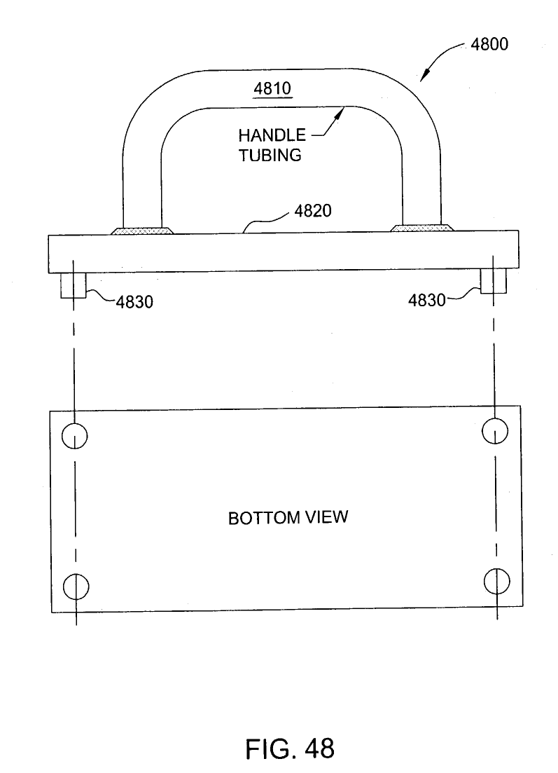

FIG. 47 illustrates an alignment of the front angled portion 4610 and a back angled portion 4620 of the present invention. Specifically, front angled portion 4610 carries at least one anchor screw hole 4612 and at least two alignment holes 4614. Similarly, back angled portion 4620 carries at least one anchor screw hole 4622 and at least two alignment holes 4624. In practice, it is desirable to align the anchor screw hole 4612 of the front angled portion with the anchor screw hole 4622 of the back angled portion as shown in FIG. 47 during installation. To assist in the alignment, an alignment tool is illustrates in FIG. 48.

FIG. 48 illustrates an anchor plate alignment tool 4800 of the present invention. The alignment tool 4800 comprises a handle 4810, a flat plate 4820 and four studs 4830. In practice, an installer will roughly align the two angled portions side by side. The installer will then insert the align tool 4800 such that the four studs 4830 will engage the alignments holes 4614 and 4624 of FIG. 47. When the alignment tool is engaged, the installer will now be sure that the anchor screw holes 4612 and 4622 are now properly aligned. The reason is that the alignment holes and anchor screw holes are drilled into the angled portions in predefined distances. This novel approach allows for rapid alignment of the anchor plate assembly during installation.

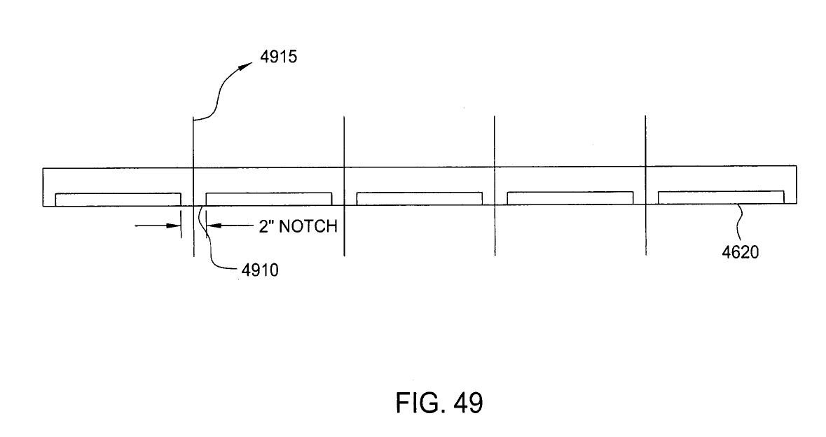

FIG. 49 illustrates an interior front view of the back angled portion 4620 of the anchor plate assembly 4600 of the present invention. Specifically, the back angled portion 4620 comprises a plurality of notches or openings 4910 that are generally equally spaced in accordance with the width of the deployed vertical shields. These notches 4910 are provided as access openings for shield installation tools. Specifically, the vertical shield can be quite heavy, thereby making it unwieldy during installation or removal of the vertical shields. By providing these access openings, the vertical shields can be lifted and shifted along the anchor plate, as required.

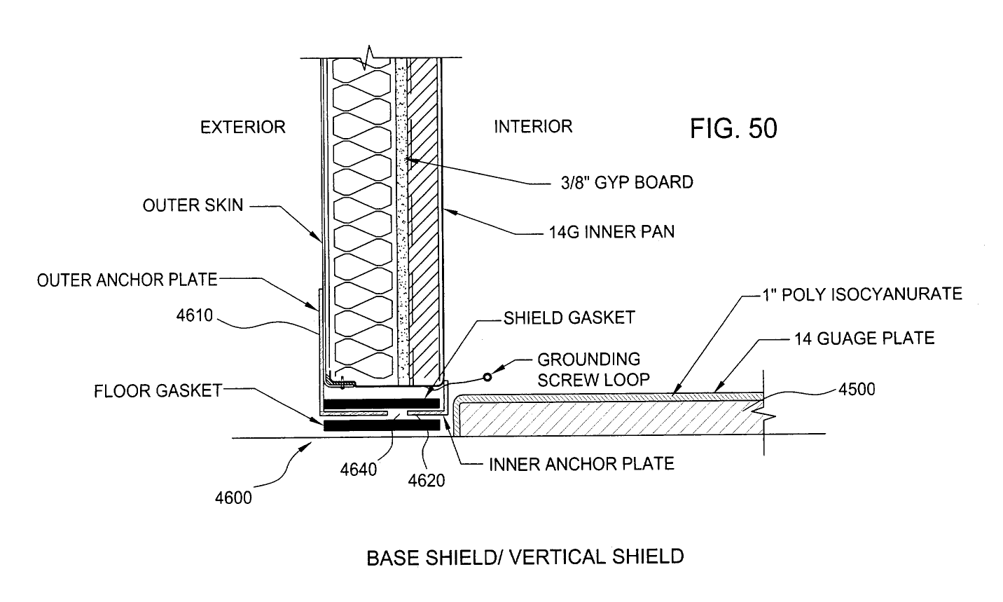

FIG. 50 illustrates the alternate anchor plate assembly 4600 as deployed next to the alternate base shield 4500 of the present invention. FIG. 50 better illustrates the air gap or fire break 4640 that is provided by the alternate anchor plate assembly 4600.

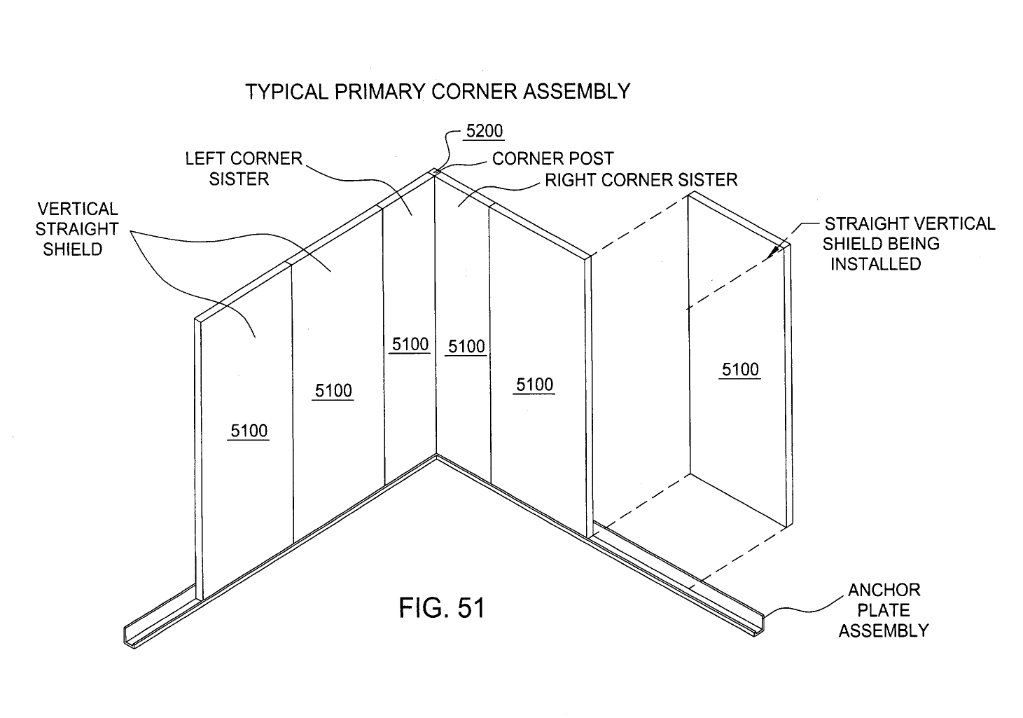

FIG. 51 illustrates an isometric view of a plurality of vertical shields 5100 that are deployed in conjunction with a post 5200 to form a corner of the present invention. Specifically, this FIG. 51 is provided to illustrate the differences between the configuration of a protective enclosure that is formed using a post versus the T-shields and corner shields as disclosed in FIGS. 14-17 above.

While the foregoing is directed to the preferred embodiment of the present invention, other and further embodiments of the invention may be devised without departing from the basic scope thereof, and the scope thereof is determined by the claims that follow.

What is claimed is:

1. A gasket comprises:
an elongated strip of flexible material wherein said flexible material comprises silicon, hydrated alumina, a flame retardant paste, di benzoyl peroxide, a minusil filler, and a cross linking peroxide.

2. A gasket comprises:
a block of flexible material having a trough for receiving a cable, wherein said flexible material comprises silicon, hydrated alumina, a flame retardant paste, di benzoyl peroxide, a minusil filler, and a cross linking peroxide.

3. A method for forming a gasket, comprising the steps of:
placing a silicone compound on a mill to allow said silicone compound to break down and warm up.
adding slowly a flame retardant paste, hydrated alumina, minusil filler, di benzoyl and cross linking peroxide to said silicone compound to form a combined mixture;
rolling and mixing said combined mixture until it is blended homogeneously throughout; and
verify the combined mixture is mixed properly by using an oscillating disc rheometer.
